(19) United States
(12) Patent Application Publication
(10) Pub. No.: US 2024/0413531 A1
(43) Pub. Date: Dec. 12, 2024

(54) RADIO

(71) Applicant: VISBAN NETWORKS LIMITED, Hertfordshire (GB)

(72) Inventors: Arokia Nathan, Hertfordshire (GB); Suk-Bae Cha, Tokyo (JP); Ryosuke Kuwada, Kanagawaken (JP); Tim Wilkinson, Norfolk (GB)

(21) Appl. No.: 18/704,423

(22) PCT Filed: Oct. 25, 2022
(86) PCT No.: PCT/GB2022/052709

§ 371 Date: Apr. 24, 2024

(30) Foreign Application Priority Data
Oct. 25, 2021 (GB) GB2115341.6
Oct. 25, 2022 (WO) PCT/GB2022/052709

(51) Int. Cl. H01Q 3/36; H01P 1/18; H01Q 1/24; H01Q 3/40; H01Q 9/04

(52) U.S. Cl. CPC H01Q 3/36; H01P 1/18; H01Q 1/24; H01Q 3/40; H01Q 9/0414

(57) ABSTRACT

A radio includes a liquid crystal (LC) phase shift layer including LC pixels. A path length of each LC pixel varies as a function of a voltage applied across the LC pixel. The radio further includes one or more planar antennae. Each of the one or more planar antennae is arranged to at least one of receive or transmit radio signals through the LC phase shift layer. The radio further includes an active matrix transistor array. Each transistor of the active matrix transistor array is configured to control a corresponding voltage across a storage capacitor. Each storage capacitor is connected across a respective LC pixel. The radio further includes a radio frequency transceiver circuit connected to the one or more planar antennae and a controller to perform beamforming of radio signals by controlling the active matrix transistor array to set the path length for each of the LC pixels.

### RELATED APPLICATIONS

This application claims the benefit under 35 U.S.C. § 371 of International Patent Application No. PCT/GB2022/052709, filed Oct. 25, 2022, which claims priority to United Kingdom Application No. GB 2115341.6, filed Oct. 25, 2021, the contents of each are incorporated by reference in their entirety.

### TECHNICAL FIELD

The present disclosure relates to an antenna assembly, a radio including the antenna assembly, and the use of the antenna assembly for beamforming in the radio. The present disclosure further relates to radios for signals with frequencies exceeding 5 GHz.

### BACKGROUND

As wireless communications networks move towards higher frequencies to improve data rates, the corresponding decrease in wavelengths can lead to issues with providing uniform coverage in areas without line of sight to a transmitter, for example, in urban areas, forested areas, inside structures and so forth.

As wireless communications networks start to move to frequencies at and above 5 GHz (sometimes termed “fifth generation” or “5G”), the effects of attenuation by atmospheric gasses such as oxygen (O₂), carbon dioxide (CO₂) and water vapor (H₂O) can be significant in some frequency bands. Atmospheric weather effects can exacerbate such issues, for example attenuation may reach in the region of 60 dB·m⁻¹.

Providing wireless network coverage to the interior of structures such as building and sports stadiums is already an issue for frequencies below 5 GHz. Moving to higher frequencies will cause further degradation of signal intensities penetrating into structures. Improvements in building glass relating to thermal regulation, for example inclusion of thin metallized layers to help keep buildings cooler, may further attenuate radio signals from the exterior.

CN 106992807 A describes a signal relay system for 5G communication. The system includes a downlink signal enhancement subsystem which includes a first receiving antenna, a first low noise amplifier module and a first transmitting antenna. The system also includes an uplink signal enhancement subsystem which includes a second receiving antenna, a second low noise amplifier module and a second transmitting antenna. The described signal relay system for 5G communication supports signal through-wall or through-glass. A 5G signal sent by a base station can be amplified and transmitted to an indoor wireless terminal, and a signal of the indoor wireless terminal can be amplified and uploaded to the base station.

US 2018/139521 A1 describes a transparent wireless bridge for providing access to an optical fiber network, including a first transceiver outside a building and configured to transmit/receive communication signals to and from the optical fiber network. A first glass sheet attached to an outer side of a window includes a first antenna communicatively coupled to the first transceiver and configured to transmit and receive communication signals to and from the first transceiver. A second glass sheet is attached to an inner side of the window and includes a second antenna configured to wirelessly transmit and receive communication signals to and from the first antenna. The wireless bridge also includes a second transceiver located inside the building that is communicatively coupled to the second antenna and configured to wirelessly transmit and receive data to and from the second antenna.

US 2015/380816 A1 describes an antenna control system and a method capable of consistently maintaining an optimum orientation point between a donor antenna and an adjacent base station. The antenna control system for receiving a signal from a base station includes a donor antenna including an antenna module disposed by being fixed to an inner side of a window glass and configured with an array antenna, a phase shifter including a plurality of transmission lines, and a phase controller configured to control the phase shifter to change an orientation direction of the antenna module. A repeater includes a measuring module for measuring a reception signal received by the antenna module. An analyzing module is for analyzing a signal quality parameter in each orientation direction of the antenna module based on a measurement result of the measuring module. A generating module is for generating an antenna control signal for controlling the orientation direction of the antenna module based on an analysis result of the analyzing module.

Deploying a network of line-of-sight relaying transceivers, for example for deploying a 5G mobile network, will require significant numbers of steerable phased array antennae. Cost and complexity of each transceiver are important factors. Whilst it is possible to produce arrays including large numbers of individually addressable antennae, there is also the question of how to drive each with a signal having an independently variable phase for beamforming.

US 2020/112095 A1 describes monitoring and compensating for environmental and other conditions affecting antenna elements of an antenna. The conditions may affect radio frequency (RF) liquid crystal of the antenna elements. In one embodiment, the antenna includes a physical antenna aperture having an array of surface scattering antenna elements that are controlled and operable together to form a beam for the frequency band for use in holographic beam steering and a compensation controller to perform compensation on the antenna elements based on monitored antenna conditions.

### SUMMARY

According to a first aspect of the present disclosure there is provided a radio including a liquid crystal, LC, phase shift layer. The LC phase shift layer includes a number of individually addressable LC pixels. A path length of each LC pixel varies as a function of a voltage applied across that LC pixel. The radio also includes one or more planar antennae. Each planar antenna is arranged to receive and/or transmit radio signals through the LC phase shift layer. The radio also includes an active matrix transistor array. Each transistor is configured to control a voltage across a corresponding storage capacitor. Each storage capacitor is connected across a respective LC pixel of the LC pixels. The radio also includes a radio frequency transceiver circuit connected to the one or more planar antennae. The radio also includes a controller configured to perform beamforming of radio signals received by and/or transmitted from the one or more planar antennae by controlling the active matrix transistor array to set the path length for each of the plurality of LC pixels.

Path length herein equals the product of geometric path length and refractive index at the respective wavelength (sometimes also termed “optical path length”). The LC phase shift layer may include polymer dispersed liquid crystal material.

The radio frequency transceiver circuit may be configured as a transmitter. The radio frequency transceiver circuit may be configured as a receiver. The radio frequency transceiver circuit may be configured as a transmitter and a receiver.

The one or more planar antennae may take the form of two or more antennae. The planar antennae may be disposed in an array. An array of planar antennae may include a planar antenna for each respective transistor of the active matrix transistor array. The geometry of the array of planar antennae may correspond to the geometry of the active matrix transistor array. In other words, a lattice and motif of the array of planar antennae may be the same as, and aligned with, a lattice and motif of transistors in the active matrix transistor array. The geometry of the array of planar antennae may differ from the geometry of the active matrix transistor array.

One or more grounded conductors may be arranged to attenuate (suppress, or even prevent) radio signal emission/reception which does not pass through the LC pixels.

The controller and the radio frequency transceiver circuit may be integrated as a single component. The controller and the radio frequency transceiver circuit may be provided by separate components.

The radio may be configured for radio signals having frequencies between and including 5 GHz and 300 GHz. The radio may be configured for radio signals having frequencies between and including 30 GHz and 300 GHz. The radio may be configured for radio signals having frequencies within one or more of the K (20 GHz to 40 GHz), L (40 GHz to 60 GHz) and M (60 GHz to 100 GHz) bands defined by NATO. The radio may be configured for radio signals having frequencies within one or more of the Ka (27 GHz to 40 GHz), V (40 GHz to 75 GHz) and W (75 GHz to 110 GHz) bands defined by the Institute of Electrical and Electronics Engineers (IEEE). The radio may be configured for radio signals having frequencies exceeding 300 GHz. The radio may be configured for radio signals having frequencies equaling or exceeding 1 THz. The radio may be configured for radio signals which are 5G signals. The radio may be configured for radio signals which are 6G signals. The radio may be configured for radio signals which are 7G signals.

The active matrix transistor array may include, or be provided by, thin-film transistors.

The LC pixels may be arranged to form an LC pixel array. The LC pixel array may be arranged according to any one of the five two-dimensional Bravais lattices. Preferably the LC pixel array is rectangular or square. Preferably the LC pixels of the LC pixel array are arranged in rows and columns corresponding to respective rows and columns of the active matrix transistor array.

The radio may be configured to relay or re-broadcast received radio signals.

The one or more planar antennae may take the form of a single planar antenna which underlies and is co-extensive with the LC pixels. Beamforming of radio signals received by and/or transmitted from the single planar antenna may arise from phase shifts introduced by the LC phase shift layer. Beamforming of radio signals received by and/or transmitted from the single planar antenna may arise exclusively from phase shifts introduced by the LC phase shift layer.

The one or more planar antennae may take the form of two or more planar antennae, each of which underlies the LC pixels. Each portion of the two or more planar antennae may be overlapped by at least one LC pixel. The number of antennae preferably does not exceed the number of LC pixels.

The two or more planar antennae may include a planar antenna corresponding to each LC pixel. Each LC pixel may overlie the respective planar antenna such that the respective planar antenna is arranged to receive and/or transmit radio signals through that LC pixel.

The radio frequency transceiver circuit may be configured to transmit to and/or receive from all of the two or more planar antennae in-phase, such that beamforming of radio signals received by and/or transmitted from the two or more planar antennae arises from phase shifts introduced by the LC phase shift layer. Beamforming of radio signals received by and/or transmitted from the two or more planar antennae may arise exclusively from phase shifts introduced by the LC phase shift layer.

The radio frequency transceiver circuit may be configured to transmit to and/or receive from each planar antenna with a corresponding electrical phase shift, such that beamforming of radio signals received by and/or transmitted from the two or more planar antennae arises from the sum of electrical phase shifts introduced by the radio frequency transceiver circuit and phase shifts introduced by the LC phase shift layer.

The radio may include a first conductor layer providing a ground layer for the LC pixels. The radio may also include a second conductor layer separated from the first conductor layer by a first dielectric layer. The second conductor layer may be patterned to provide radiating conductors of the one or more planar antennae. The radio may also include a third conductor layer separated from the second conductor layer by a layer of liquid crystal material. The third conductor layer may be patterned to provide pixel electrodes defining respective pixels of the LC phase shift layer.

The LC phase shift layer may include the layer of liquid crystal material, the first conductor layer and the third conductor layer. The first conductor layer may be a uniform (i.e. unpatterned) electrode. The first conductor layer may be patterned to define a number of electrodes. The first conductor layer may also provide a ground layer for the one or more planar antennae.

In relation to layers described herein, unless stated otherwise the description that a layer “A” is separated from a layer “B” by a layer “C” encompasses at least the following configurations:

Layers “A” and “B” directly contacting opposite faces of layer C;

One or more intervening layers between layer A and layer C;

One or more intervening layers between layer “B” and layers “C”; or

One or more intervening layers between layer “A” and layer “C” and one or more further intervening layers between layer “C” and layer “B”.

The one or more planar antennae may take the form of two or more planar antennae. The radio may also include a fourth conductor layer patterned into a number of LC pixel electrodes and two or more antenna electrodes. Each LC pixel electrode may define a respective pixel of the LC phase shift layer. Each antenna electrode may provide a radiating conductor of a respective one of the two or more planar antennae. The radio may also include a fifth conductor layer separated from the fourth conductor layer by a layer of liquid crystal material. The fifth conductor layer may provide a ground layer for the plurality of LC pixels. The fifth conductor layer may be configured to minimize attenuation of signals received by and/or transmitted from the two or more planar antennae.

The LC phase shift layer may include the layer of liquid crystal material, the fourth conductor layer and the fifth conductor layer. The LC pixel electrodes may be interspersed with the antenna electrodes within the same layer. Each LC pixel electrode may surround an antenna electrode.

The fifth conductor layer may be impedance matched to permit passage of radio signals having for which the radio is configured. The fifth conductor layer may take the form of a single conductor having a mesh structure. Spacing of elements forming the mesh structure may be configured to minimize attenuation of signals received by and/or transmitted from the two or more planar antennae. The fifth conductor layer may be patterned into two or more LC bias electrodes. Each LC bias electrode may correspond to a respective LC pixel electrode.

The fifth conductor may also provide a ground plane for the two or more planar antennae.

The radio may also include a sixth conductor layer providing a ground layer for the two or more planar antennae. The sixth conductor layer may be separated from the fourth conductor layer by a second dielectric layer. The fourth conductor layer may lie between the second dielectric layer and the layer of liquid crystal material.

The second dielectric layer may take the form of a thin-film transistor (TFT) substrate providing the active matrix transistor array. The TFTs of the active matrix transistor array may be arranged so as to avoid overlapping with antenna electrodes.

The one or more planar antennae may take the form of two or more planar antennae. The radio may include a seventh conductor layer patterned into two or more LC pixel electrodes. Each LC pixel electrode may define a respective pixel of the LC phase shift layer. Each LC pixel electrode may also provide a radiating conductor of the two or more planar antennae. The radio may also include an eighth conductor layer separated from the fourth conductor layer by a layer of liquid crystal material. The fifth conductor layer may provide a ground layer for the LC pixels. The fifth conductor layer may be configured to minimize attenuation of signals received by and/or transmitted from the two or more planar antennae. The radio frequency transceiver circuit may be capacitively coupled to each of the two or more planar antennae.

The LC phase shift layer may include the layer of liquid crystal material, the seventh conductor layer and the eighth conductor layer.

The eighth conductor layer may be impedance matched to permit passage of radio signals at frequencies for which the radio is configured. The eighth conductor layer may take the form of a single conductor having a mesh structure. Spacing of elements forming the mesh structure may be configured to minimize attenuation of signals received by and/or transmitted from the two or more planar antennae. The eighth conductor layer may be patterned into two or more LC bias electrodes. Each LC bias electrode may correspond to a respective LC pixel electrode. The eighth conductor layer may be patterned as the inverse of the seventh conductor layer, such that each of the LC pixel electrodes coincides with a gap in the eighth conductor layer.

A TFT substrate providing the active matrix transistor array may also be disposed between the layer of liquid crystal material and the seventh conductor layer.

The eighth conductor may also provide a ground plane for the two or more planar antennae.

The radio may also include a ninth conductor layer providing a ground layer for the two or more planar antennae. The ninth conductor layer may be separated from the seventh conductor layer by a third dielectric layer. The seventh conductor layer may lie between the third dielectric layer and the layer of liquid crystal material.

The one or more planar antennae may take the form of two or more planar antennae. The radio may include a tenth conductor layer patterned into two or more antenna electrodes. Each antenna electrode may provide a radiating conductor of a respective one of the two or more planar antennae. The radio may also include an eleventh conductor layer separated from the tenth conductor layer by a fourth dielectric layer. The eleventh conductor layer may provide a ground layer for the LC pixels. The eleventh conductor layer may be configured to minimize attenuation of signals received by and/or transmitted from the two or more planar antennae. The radio may also include a twelfth conductor layer separated from the eleventh conductor layer by a layer of liquid crystal material. The twelfth conductor layer may be patterned into a plurality of LC pixel electrodes. Each LC pixel electrode may define a respective pixel of the LC phase shift layer.

The eleventh conductor layer may also provide a ground plane for the two or more planar antennae.

The radio may also include a thirteenth conductor layer providing a ground layer for the two or more planar antennae. The thirteenth conductor layer may be separated from the tenth conductor layer by a fifth dielectric layer. The tenth conductor layer may lie between the fifth dielectric layer and the fourth dielectric layer.

The LC material of the LC phase shift layer may have a thickness in the range between 100 μm and 5 mm. The LC material of the LC phase shift layer may have a thickness in the range between 500 μm and 2 mm. The LC material of the LC phase shift layer may have a thickness in the range between 500 μm and 1.5 mm. The LC material of the LC phase shift layer may have a thickness in the range between 800 μm and 1.2 mm.

The radio may also include a second liquid crystal, LC, phase shift layer including two or more individually addressable second LC pixels. A path length of each second LC pixel may vary as a function of a voltage applied across that second LC pixel. The radio may also include one or more second planar antennae. Each second planar antenna may be arranged to receive and/or transmit radio signals through the second LC phase shift layer. The radio may also include a second active matrix transistor array. Each transistor of the second active matrix transistor array may be configured to control a voltage across a corresponding second storage capacitor. Each second storage capacitor may be connected across a respective second LC pixel of the second LC pixels. The radio frequency transceiver circuit may be connected to the one or more second planar antennae. The controller may be further configured to perform beamforming of radio signals received by and/or transmitted from the one or more second planar antennae by controlling the second active matrix transistor array to set the path length for each of the plurality of second LC pixels. The controller may be further configured to control, using the active matrix transistor array, the one or more antennae as a first phased array to receive radio signals, the first phased array being directional and controllably orientable to a receive direction. The controller may be further configured to control, using the second active matrix transistor array, the one or more second antennae as a second phased array to retransmit the radio signals received using the first phased array, the second phased array being directional and controllably orientable to a transmit direction.

The planar antennae and/or the second planar antennae may be supported on a common substrate. The LC phase shift layer and/or the second LC phase shift layer may be supported on the common substrate. The active matrix transistor array and/or the second active matrix transistor array may be supported on the common substrate. The radio frequency transceiver circuit and/or the controller may also be supported on the common substrate.

The common substrate may include, or take the form of, a flexible film or sheet. Electrical components of the radio may be supported, deposited, patterned and/or integrated on (or with) one or both sides of the common substrate. The common substrate may take the form of a multi-layer printed circuit board. Electrical components of the radio may include, without limitation, the active matrix transistor array, the second active matrix transistor array, the storage capacitors, the second storage capacitors, the radio frequency transceiver circuit, the controller, the LC phase shift layer and/or the second phase shift layer. Interconnections between electrical components of the radio supported on opposite faces of the common substrate may be provided using through vias.

The common substrate may include, or take the form of, a laminate. If the common substrate is a laminate, one or more electrical components of the radio may be supported, deposited, patterned and/or integrated on (or within) one or more internal layers of the laminate. If the common substrate is a laminate, the laminate may include one or more layers of glass and/or plastic and/or adhesive. The laminate may include one or more conductor layers. Conductor layers of the laminate may be internal (i.e. between the first and second faces), and/or external (i.e. supported on the first and/or second faces). One or more layers of the laminate may support one or more electrical components of the radio.

The active matrix transistor array and/or the second active matrix transistor array may be integrated on and/or in the common substrate. The active matrix transistor array and/or the second active matrix transistor array may be flip-chip bonded to the common substrate. The storage capacitors and/or the second storage capacitors may be integrated on and/or in the common substrates. The storage capacitors and/or the second storage capacitors may be flip-chip bonded to the common substrate. The radio frequency transceiver circuit may be integrated on and/or in the common substrate. The radio frequency transceiver circuit may be flip-chip bonded to the common substrate. The controller may be integrated on and/or in the common substrates. The controller may be flip-chip bonded to the common substrate. Components may be flip-chip bonded to one or both sides of the common substrate.

The common substrate may be transparent. Transparent may correspond to the common substrate having a minimum transmission of 50% for visible wavelengths. Visible wavelength may correspond to a range between 380 nm and 750 nm. A portion of the radio supporting, providing and/or forming the one or more planar antennae and/or the one or more second planar antennae may be transparent or opaque.

The common substrate may include, or be formed from, glass. The common substrate may include, or take the form of, one or more plastics including but not limited to polycarbonate (PC), polyimide (PI), polyethylene terephthalate (PET), polyethylene naphthalate PEN, cyclo-olefin polymer (COP), or any other polymer having sufficient mechanical strength to support the radio and sufficient transparency to be seen through.

When one or more electrical components of the radio are flip-chip bonded to the common substrate, such electrical components may be flip-chip bonded to the common substrate in accordance with the Heterogeneous Integration Roadmap, HIR. The Heterogeneous Integration Roadmap (HIR) is a set of guidelines developed for silicon systems-in-package (SiP) technologies. HIR may refer to, for example, the guidelines set out in the publication of the HIR 2019 edition.

The common substrate may incorporate a heat spreader layer. The heat spreader layer may be incorporated during a heterogeneous integration fabrication process. A heat spreader layer may enable operation at higher power and/or using a higher density electrical components and interconnects without requiring a fan or other cooling method. For example, a ground plane layer for one or more antennae and/or the LC pixels may be formed from copper and may additionally serve as a heat spreader layer.

The radio may include a planar substrate having first and second opposite faces and having a thickness between the first and second opposite faces. The one more planar antennae and the LC phase shift layer may be supported on the first face. The one or more second planar antennae and the second LC phase shift layer may be supported on the second face. The radio frequency transceiver circuit may be supported by the planar substrate and may include a plurality of vias formed through the thickness of the planar substrate for transmission of signals between the radio frequency transceiver circuit and the one or more planar antennae and/or between the radio frequency transceiver circuit and the one or more second planar antennae.

The planar substrate may include, or take the form of, the common substrate described hereinbefore.

The radio frequency transceiver circuit may include a first microstrip line supported on the first face and a second microstrip line support on the second face. The first and second microstrip lines may be connected by corresponding vias. Vias connecting between microstrip lines supported on the first and second faces may be impedance matched to the microstrip lines. The radio frequency transceiver circuit may include a number of first microstrip lines supported on the first face. The radio frequency transceiver circuit may include a number of second microstrip lines supported on the second face. Any microstrip line may be connected by vias extending through the planar substrate to one or more microstrip lines and/or other components of the radio frequency transceiver circuit supported on the opposite side of the planar substrate.

The radio frequency transceiver circuit may include one or more components flip-chip bonded to the planar substrate. One or more components of the radio frequency transceiver circuit may be flip-chip bonded to the first face. One or more components of the radio frequency transceiver circuit may be flip-chip bonded to the second face. One or more components of the radio frequency transceiver circuit may be flip-chip bonded to the first face and one or more further components may be flip-chip bonded to the second face. The one or more components of the radio frequency transceiver circuit may be flip-chip bonded to the planar substrate in accordance with the Heterogeneous Integration Roadmap, HIR.

In some examples, any or all of the radio frequency transceiver circuit, the active matrix transistor array, the second active matrix transistor array and/or the controller may include no printed circuit board substrates. Although these components may include no printed circuit board substrates, any or all of them may be connected to separate devices, for example a power supply, which may include printed circuit board substrates.

The radio frequency transceiver circuit may include one or more filters. The filters may be arranged to filter signals between the radio frequency transceiver circuit and a planar antenna and/or between the radio frequency transceiver circuit and a second planar antenna. A filter may include, or take the form of, a film bulk acoustic resonator, FBAR. A filter may include, or take the form of, a thin-film bulk acoustic resonator, TFBAR. A filter may include, or be formed from, metamaterials. Metamaterial filters suitable for use in the radio frequency transceiver circuit include, without being limited to, metamaterial filters described in “Metamaterial Structure Inspired Miniature RF/Microwave Filters”, Abdullah Alburaikan, PhD Thesis (2016), The University of Manchester, https://www.escholar.manchester.ac.uk/uk-ac-man-scw: 305308, (see in particular pages 56 onwards). Filters may be integrated into a transmission line between the radio frequency transceiver circuit and the one or more planar antennae and/or between the radio frequency transceiver circuit and the one or more second planar antennae. For example, in the form of one or more distributed-element filters. Filters may be provided in the form of a variation in impedance along a portion of a transmission line.

The planar substrate may incorporate a heat spreader layer (not shown). The heat spreader layer may be incorporated during a heterogeneous integration fabrication process. A heat spreader layer may enable operation at higher power and/or using a higher density of antennae and/or microstrip interconnects without requiring a fan or other cooling method. In some examples, a ground plane layer (for example formed as part of the antennae and/or the second antennae) may be formed from copper and may additionally serve as a heat spreader layer. Additionally or alternatively, an antenna dielectric layer may be formed from a dielectric with relatively high thermal conductance, for example AlN, or AlOx (in particular Al₂O₃ in the sapphire structure) may also serve as a good heat spreader layer.

The controller may be further configured to receive or generate a phase image. Each pixel of the phase image may correspond to a transistor of the active matrix transistor array, and may store a voltage for application to the associated storage capacitor. The controller may be further configured to control the active matrix transistor array to set the voltages of each storage capacitor according to the values of the phase image. The phase image may alternatively be described as a hologram. Herein the term “hologram” may also be used to describe a 3D wave pattern formed by interference between radio signals phase shifted by different amounts. In other words, the term “hologram” may be applied to the phase image, or to a wave pattern emitted from the radio.

The radio frequency transceiver circuit may include one or more amplifiers. Additionally or alternatively, the radio may include one or more amplifiers connected between the radio frequency transceiver circuit and the one or more planar antennae and/or between the radio frequency transceiver circuit and the one or more second planar antennae. The radio frequency transceiver circuit may include one or more filters. Additionally or alternatively, the radio may include one or more filters connected between the radio frequency transceiver circuit and the one or more planar antennae and/or between the radio frequency transceiver circuit and the one or more second planar antennae.

If the radio includes filters, the filters may be supported by, formed on, or formed within, the common substrate and/or the planar substrate. The radio may include one or more filters in any form described hereinbefore in relation to the radio frequency transceiver circuit. If the radio includes amplifiers, the amplifiers may additionally be supported by the common substrate and/or the planar substrate. The radio may include one or more amplifiers in the form of CMOS amplifiers supported by, formed on, or formed within the common substrate and/or the planar substrate.

Some or all of the amplifiers may take the form of low noise amplifiers. Some or all of the amplifiers may take the form of power amplifiers. When the radio is configured as a transceiver (transmission and reception), each planar antenna or second planar antenna may be connected to the radio frequency transceiver circuit via a path which is switchable between a low noise amplifier in a receive mode and a power amplifier in a transmit mode. When the radio is configured as a transceiver, a subset of the planar antennae and/or second planar antennae may be receiver antennae connected to the radio frequency transceiver circuit via one or more low noise amplifiers, and the remaining first antennae and/or second planar antennae (i.e. the complement of the subset) may be transmitting antennae connected to the radio frequency transceiver circuit via one or more power amplifiers.

A system may include two or more of the radios. Each radio of the two or more radios may be configured to coordinate beamforming with each other radio of the two or more radios.

The two or more radios may be located in the same general vicinity, for example within a 200 m sphere. Each of the two or more radios may be located within 200 m, within 100 m, within 50 m, within 20 m or within 10 m of at least one other radio of the two or more radios.

The two or more radios may be connected via a wired network. The two or more radios may be connected via a wireless network. The two or more radios may be connected via a network including wired and wireless links.

The system may also include a central control unit configured to coordinate beamforming of the two or more radios. The central control unit may take the form of one radio of the two or more radios. The system may be configured such that coordination of beamforming is executed in a distributed manner, using the controllers of two or more radios.

The two or more radios may be configured to coordinate beamforming to direct reception and/or transmission of two or more radios towards a first external source.

The two or more radios may be configured to coordinate beamforming towards at least two spatially separated external sources.

The two or more radios may be supported by a structure. The structure may be a building. Each radio may be supported by a window or a wall of the building. Each radio may be supported by a different window. Two or more radios may be supported by the same window. The structure may be a bus shelter, a lamp post, or any other item of street furniture. Supported by a structure may include attachment to the structure, mounting to the structure, and so forth. Supported by a structure may additionally or alternatively include radios being incorporated into, or integrally formed with, the structure. The two or more radios making up the system may be supported by two or more separate structures (structures having the same meaning as already explained).

All or some of the two or more radios may be arranged in an array, such that the planar antennae of at least two radios may be utilized as a first macro-phased array. When second planar antennae are included, these may additionally or alternatively be utilized as a second macro-phase array.

According to a second aspect of the present disclosure, there is provided an antenna assembly including a liquid crystal, LC, phase shift layer. The LC phase shift layer includes a number of individually addressable LC pixels. A path length of each LC pixel varies as a function of a voltage applied across that LC pixel. The antenna assembly also includes one or more planar antennae formed of metal. Each planar antenna is arranged to receive and/or transmit radio signals through the LC phase shift layer. Each planar antenna is configured for radio signals having a frequency within a range from 5 GHz to 300 GHz.

The antenna assembly may be included in a radio according to the first aspect. The antenna assembly may include features corresponding to any features of the radio according to the first aspect or a system including that radio. Definitions applicable to the radio according to the first aspect, or a system including that radio, may be equally applicable to the antenna assembly.

The antenna assembly may not correspond to all or part of a liquid crystal display. The antenna assembly may not include crossed polarizers.

The LC phase shift layer and the planar antenna may be integrated on a common substrate.

The antenna assembly may also include an active matrix transistor array. Each transistor of the active matrix transistor array may be configured to control a voltage across a corresponding storage capacitor. Each storage capacitor may be connected across a respective LC pixel of the plurality of LC pixels.

The active matrix transistor array may be integrated on the common substrate.

According to a third aspect of the present disclosure, there is provided a method of using a radio according to the first aspect, or a system including that radio. The method includes controlling beamforming of radio signals received by and/or transmitted from the one or more planar antennae by controlling the active matrix transistor array to set the path length for each of the plurality of LC pixels.

The method may include features corresponding to any features of the radio of the first aspect or the system including that radio.

### BRIEF DESCRIPTION OF THE DRAWINGS

Certain embodiments of the present disclosure will now be described, by way of example, with reference to the accompanying drawings in which:

FIG. 1 is a schematic block diagram of a radio transceiver;

FIG. 2 is a circuit diagram corresponding to part of an exemplary radio transceiver;

FIG. 3 schematically illustrates a first antenna assembly;

FIG. 4 is a schematic cross section of a first stack-up;

FIG. 5 is a schematic block diagram of a first radio transceiver configuration;

FIG. 6 is a schematic block diagram of a second radio transceiver configuration;

FIG. 7 is a schematic block diagram of a third radio transceiver configuration;

FIG. 8 is a schematic block diagram of a fourth radio transceiver configuration;

FIG. 9 is a schematic block diagram of a fifth radio transceiver configuration;

FIG. 10 is a schematic plan view of a first type of planar antennae;

FIG. 11 is a schematic plan view of a second type of planar antennae;

FIG. 12 is a schematic plan view of a third type of planar antennae;

FIG. 13 is a schematic plan view of a fourth type of planar antennae;

FIG. 14 is a schematic plan view of a fifth type of planar antennae

FIG. 15 is a schematic plan view of an alternative arrangement of fifth planar antennae shown in FIG. 14;

FIG. 16 schematically illustrates a second antenna assembly;

FIG. 17 is a schematic cross section of a second stack-up;

FIG. 18 schematically illustrates a third antenna assembly;

FIG. 19 is a schematic cross section of a third stack-up;

FIG. 20A is schematic plan view of an LC pixel electrode and an antenna electrode;

FIG. 20B is schematic plan view of an LC bias electrode;

FIG. 21 schematically illustrates a fourth antenna assembly;

FIG. 22 is a schematic cross section of a fourth stack-up;

FIG. 23 schematically illustrates a fifth antenna assembly; and

FIG. 24 is a schematic cross section of a fifth stack-up.

### DETAILED DESCRIPTION

In the following description, like parts are denoted by like reference numerals.

The problems of line-of-sight to a base station and atmospheric and/or weather attenuation of radio signals may be addressed by adding further wireless transceivers to a wireless network. However, in order to do this in practice, wireless transceivers are required which are small, high-gain, steerable and inexpensive and which do not require large amounts of power. The direction of the Poynting vector of radio signals, especially for non-line-of-sight environments, is important to maximizing quality of service performance. It is also desirable that the wireless transceivers used should be aesthetically unobtrusive, i.e. small and preferably easy to disguise and/or integrate into an environment. The present specification describes antenna assemblies for radio transceivers which address, amongst other problems, these issues.

The current infrastructure for wireless communications is expected to encounter limitations and underlying issues which will make it difficult to scale towards higher frequencies, for example towards (or beyond) mm-waves. As the demand for higher bandwidth is driven ever upwards for new services such as mobile data, content streaming and so forth, the size of an area (or “cell”) covered by a single transmitter tower had become increasingly small. This trend is expected to continue for frequencies above 5 GHZ, often referred to as “5G”. The current conventional infrastructure of cell towers is already approaching its limits, and a new approach is required as wireless communications networks increasing move towards a line-of-sight, point-to-multipoint system operating at high frequencies and high data rates. Such high frequency communications, for example mm-wave, may also benefit considerably from the use of massively multi-input-multiple-output antenna architectures to allow beam-forming and beamsteering. Highly directional operation may help to avoid issues with multi-path interference.

Driven by consumer demands for increasingly diverse and immersive mobile data services, for example High-definition video streaming, cloud-based services, augmented reality and so forth, next generation wireless communication networks and systems will need to offer high throughput, low latency and reliability to remain competitive. For example, beyond the currently planned infrastructure to move up to 6 GHz, there is an additional 200 GHz of spectrum available at mm-wave frequencies that is under-utilized, and which could potentially support data rates in the region of 10 to 50 Gb per second.

Wide spectrum does not mean it is unlimited, and other services will also utilize the same, or neighboring, bands. If significant portion of spectrum is exclusively granted to a single independent mobile network operator, there will be inefficiency of spectrum utilization. An average consumer may utilize cm-waves with spectrum ranging from 3 to 30 GHz, and between 30 and 40 GHz (up to 300 GHz) as a mm-wave spectrum.

There is also spectrum sharing at 60 to 70 GHz for mission-critical services, which includes smart city infrastructure, healthcare, self-driving cars, and many other applications. Such services should preferably have access to a continuous high-speed, low-latency connection, and shared spectrum has the potential to help ensure that devices are always connected.

The present specification is concerned with antenna assemblies which may perform beamsteering for phased arrays, whilst reducing the complexity and costs of generating the required phase shifts between signals emitted from adjacent antennae. In particular, the present specification employs active matrix control of liquid crystal cells (or “pixels”) for beamforming, both independently of electronically generated phase shifts and/or in combination with electronically generated phase shifts (for example to refine conventional beamforming outputs).

The present specification is also concerned with radio transceivers (or simply “radios”) which incorporate the antenna assemblies and may be configured for relaying radio signals, in particular radio signals exceeding 5 GHz used for data transmission in wireless communications networks (for example mobile/cell services). Amongst other features, the radio transceivers described herein are compact and low profile, allowing for straightforward attachment to, or integration into, structures in a built environment. Radio transceivers according to the present specification may be particularly suitable for attachment to, or integration into, window glass, and may retain sufficient transparency to be see-through to human observers.

These features allow radio transceivers to be added to structures in order to improve range, reduce blind spots, relay signals to the interior of structures or underground (for example metro transit systems), and so forth.

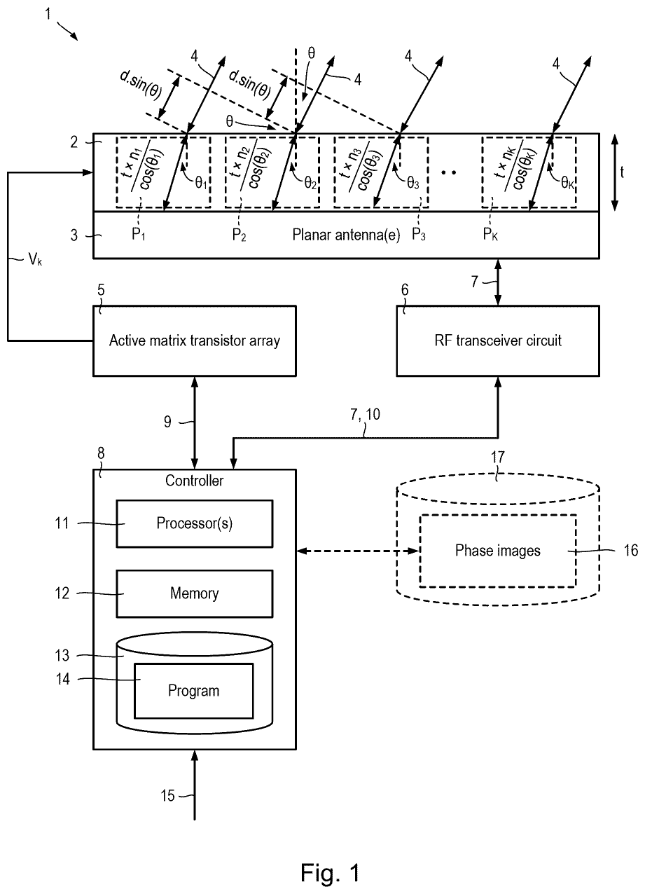

Referring to FIG. 1 a radio transceiver 1 is shown.

The radio transceiver 1 includes a liquid crystal (LC) phase shift layer 2 which includes a number K of individually addressable LC pixels P₁, . . . , Pₖ, . . . , P_{K}, with Pₖ denoting the k^{th} of K LC pixels. The LC phase shift layer 2 includes liquid crystal material, preferably in the form of polymer dispersed liquid crystal (PDLC). For example, a PDLC material may include a mixture of cyanobiphenyl and cyanoterphenol components, for example E7 liquid crystal sold by Merck (RTM). A PDLC material may be mixed dissolved in an acrylate material (for example Norland (RTM) Optical Adhesive 81) at a concentration in the range of 20 to 30% by weight (for example 25% by weight). The LC phase shift layer 2 has a thickness t. The thickness may range from several hundred μm up to several mm, depending on the specific LC material used and the desired range of angles for beamforming.

The radio transceiver 1 also includes one or more planar antennae 3, each of which is arranged to receive and/or transmit radio signals 4 through the LC phase shift layer 2. For example, the liquid crystal (LC) phase shift layer 2 may take the form of a flat layer overlying radiating conductors of the one or more planar antennae 3, as shown in FIG. 1. One or more grounded conductors (not shown in FIG. 1) may be arranged to attenuate (i.e. suppress, or even prevent) emission/reception of radio signals 4 which do not pass through LC phase shift layer 2.

A path length for transmission of radio signals 4 through each LC pixel Pₖ to the one or more planar antennae 3 varies as a function of a voltage applied across that LC pixel Pₖ. Path length in this context equals the product of geometric path length and refractive index at the respective wavelength, and in is sometimes alternatively referred to as “optical path length”, though in this case the electromagnetic radiation concerned is not visible light. In particular, the dielectric constant varies in dependence on the local alignment direction of liquid crystal molecules, due to anisotropic polarizability. Consequently the refractive index n of each LC pixel Pₖ is a function n (V) of the voltage V (strictly the corresponding electric field) applied across that LC pixel Pₖ. If the voltage applied to the k^{th} LC pixel Pₖ is denoted Vₖ, let the corresponding refractive index n be denoted nₖ(Vₖ) or simply nₖ.

If the LC pixels Pₖ are spaced apart with a regular spacing d, then the path difference between adjacent LC pixels Pₖ, Pₖ₊₁ has two components, a first due to geometric effects and a second due to differences in refractive indices nₖ, nₖ₊₁. The geometric contribution is the same as for any phased array. For radio signals 4 incident at an angle θ, the geometric path difference is d·sin (θ). In a conventional phased array, electronics would be used to compensate for the geometric path difference d·sin (θ) so that the radio signals 4 may be emitted or received in phase by the one or more planar antennae 3, despite the geometric path difference d·sin (θ).

In the radio transceiver 1 of FIG. 1, compensation for the geometric path difference d.cos (θ) is instead provided by the tunable path lengths of the LC pixels Pₖ. The refractive index nₖ of an LC pixel Pₖ causes refraction of the angle of a radio signal 4 to a local angle θk:

$${θ}_{k} = arc sin ( \frac{{n}_{0} sin ( θ )}{{n}_{k}} ) \qquad ( 1 )$$

In which no is the refractive index of air (n₀≈1). The optical path length of the k^{th} pixel is then:

$${OPL}_{k} = \frac{t \cdot {n}_{k}}{cos ( {θ}_{1} )} \qquad ( 2 )$$

In which OPLₖ is the optical path length of the k^{th} LC pixel Pₖ. The optical path difference ΔOPL between adjacent LC pixels Pₖ, Pₖ₊₁ is then:

$$Δ OPL = {OPL}_{k} - {OPL}_{k + 1} \qquad ( 3 )$$

For beamforming, it is needed for the optical path difference ΔOPL to equal the geometric path difference, i.e.:

$$Δ OPL = d \cdot sin ( θ ) \qquad ( 4 )$$

As an example, for an incidence angle of θ=10⁰=π/18 and a pixel spacing of d=2 mm, the geometric path difference is d·sin (θ)=0.35 mm. If the refractive index for the k^{th} LC pixel Pₖ is nₖ=3 and that for the k+1th LC pixel Pₖ₊₁ is nₖ+1=1.5, then the respective angles are θₖ=3.32⁰ and θₖ₊₁=6.65⁰. In order for the geometric path difference to be entirely cancelled by the optical path difference between the LC pixels Pₖ, Pₖ₊₁, a thickness of only 0.23 mm (230 μm) is needed.

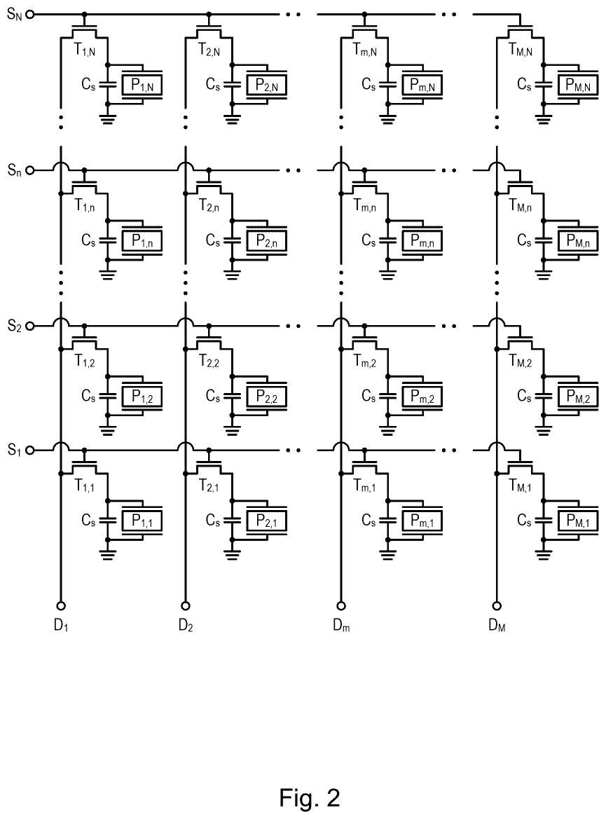

The radio transceiver 1 also includes an active matrix transistor array 5 configured to control the voltages V₁, . . . , V_{K} applied across each of the LC pixels P₁, . . . , P_{K}. Each transistor (see FIG. 2) of the active matrix transistor array 5 is configured to control the voltage Vₖ across a corresponding storage capacitor (see FIG. 2), and that storage capacitor is in turn connected across a respective LC pixel Pₖ of the LC phase shift layer 2. The active matrix transistor array 5 is preferably implemented using thin-film transistors, although any transistors suitable for an active matrix addressing arrange may be used instead.

The radio transceiver 1 also includes a radio frequency transceiver circuit 6 connected to the one or more planar antennae 3. The radio frequency transceiver circuit 6 transmits and/or receives radio frequency signals 7 to and/or from the one or more planar antennae 3. The radio frequency signals 7 correspond to the incident radio signals 4 plus the phase shifts applied by the LC phase shift layer 2. The radio frequency transceiver circuit 6 may be configured as a transmitter, as a receiver, or preferably as a transmitter and a receiver (whether concurrently or time-multiplexed). In some examples, the radio transceiver 1 may be configured to relay or re-broadcast received radio signals 4.

The radio transceiver 1 also includes a controller 8 configured to perform beamforming of the radio signals 4 received by and/or transmitted from the one or more planar antennae 2 by controlling the active matrix transistor array 5 to set the optical path lengths for each of the plurality of LC pixels P₁, . . . , P_{K}. In particular, the controller 8 outputs active matrix control signals 9 to the active matrix transistor array 5 to set the voltages V₁, . . . , V_{K}. As described hereinafter, advantageously the active matrix control signals 9 may be configured according to any known active matrix addressing scheme, for example as used in conventional active matrix displays. Optionally, the controller 8 may also control the radio frequency transceiver circuit 6, for example to generate, process and/or relay the radio frequency signals 7 and/or control signals 10. Alternatively, the radio frequency transceiver circuit 6 may be controlled independently of the active matrix transistor array 5.

The controller 8 may receive control signals 15, for example, from a device (not shown) which incorporates the controller 8. For example, the control signals 15 may provide radio frequency signals 7, target directions for beamforming and so forth.

The controller 8 may take the form of a microcontroller or a computing device (for example a mobile phone) including one or more processors 11, volatile memory 12, and non-volatile storage 13. The non-volatile storage 13 stores program code 14 which, when executed by the one or more processors 11 causes the controller 8 to implement the functions described herein. The controller 8 is not limited to implementation using a microcontroller or computing device, and may alternatively be implemented in an application specific integrated circuit (ASIC), a field-programmable gate array (FPGA), or any other device suitable to perform the required functions.

Although illustrated as separate components in FIG. 1, in other examples the controller 8 and the radio frequency transceiver circuit 6 may be integrated as a single component.

In this way beamforming may be performed using as few as a single planar antenna 3, with phase shifts being applied by the LC phase shift later 2 as radio signals 4 pass through. The active matrix 5 control of the LC pixels P₁, . . . , Pₖ provides a conveniently implemented, compact and scalable approach to controlling beamforming of a large number of elements. Moreover, application of voltages V₁, . . . , V_{K} is less complex, compared to conventionally beamforming K elements.

The LC phase shift layer 2 and the one or more planar antennae 3 may be integrated, for example supported on a common substrate, to provide an antenna array which as an integrated component of the radio transceiver 1. The antenna array may also include the active matrix transistor array 5, integrated with the LC phase shift layer 2 and the one or more planar antennae 3 on the common substrate.

The radio transceiver 1 is configured for radio signals 4 having carrier frequencies between and including 5 GHz and 300 GHz. In some examples, the radio transceiver 1 may be configured for radio signals 4 having carrier frequencies exceeding 300 GHz, or even equaling or exceeding 1 THz. The 5G wireless communications standard is one example of suitable radio signals 4, though subsequent generations may also be used (for example 6G, 7G and so forth).

Referring also to FIG. 2, the LC pixels Pₖ of the LC phase shift layer may be arranged into an array which corresponds to the active matrix transistor array 5.

Having the pixels Pₖ of the LC phase shift layer arranged into an array corresponding to the active matrix transistor array 5 may facilitate integration of the LC phase shift layer 2 and the active matrix transistor array 5. For example, each LC pixel Pₖ may be arranged directly adjacent to a corresponding transistor and storage capacitor.

The K LC pixels Pₖ may be arranged into N rows and M columns, with K=N×M. Let the LC pixel Pₖ corresponding to the n^{th} row and m^{th} column be denoted P_{m,n}. In this example, the active matrix transistor array 5 is controlled using M drive lines D₁, . . . , Dₘ, . . . , D_{M} and N addressing lines S₁, . . . , Sₙ, . . . , S_{N}. Each pair of a drive line Dₘ and an addressing line Sₙ are coupled by a respective transistor T_{m,n} of the active matrix transistor array 5. The addressing line Sₙ is connected to the gate of the transistor T_{m,n}, and the drive line Dₘ is connected to one end of the transistor channel (source or drain, depending on polarities). The other end of the transistor channel is coupled to ground via a respective storage capacitor Cs. The storage capacitor Cs is connected in parallel across the corresponding LC pixel P_{m,n}.

To set the voltage V_{m,n} for the LC pixel P_{m,n}, the m^{th} drive line Dₘ is connected to the desired voltage value, and the addressing line Sₙ is biased so as to open the channel of transistor T_{m,n}, The connected storage capacitor Cs is charged to the voltage value applied on the drive line Dₘ, and the transistor T_{m,n} is switched off. In this way, the voltage value V_{m,n} may be set for each LC pixel P_{m,n}. Due to decay of the voltages V_{m,n} because of leakage currents, the voltage values V_{m,n} on the storage capacitors Cs are regularly refreshed by scanning the array 5. In this way, the active matrix transistor array 5 may be controlled in an analogous way to an active matrix display screen.

The controller 8 may optionally be configured to receive, retrieve or generate a phase image 16. For example, phase images 16 may be included in control signals 15, retrieved from the internal storage 13 of the controller, generated by the one or more processors 11 and/or retrieved from further storage 17 external to the controller 8. Each pixel of the phase image 16 corresponds to a transistor T_{m,n} of the active matrix transistor array 5, and stores a voltage value V_{m,n} for application to the associated storage capacitor Cs and LC pixel P_{m,n}. The controller 8 can control the active matrix transistor array 5 to set the voltages V_{m,n} of each storage capacitor according to the values store in the phase image 17. This approach may allow the use of a controller 8 configured for use with a conventional LCD display. Phase images 17 may also provide useful visualizations of the phase patterns being output using the LC phase shift layer 2.

The phase images 17 may alternatively be described as “holograms”. Herein the term “hologram” may also be used to describe a 3D wave pattern formed by interference between radio signals 4 phase shifted by different amounts by the antenna assembly. In other words, the term “hologram” may be applied to the phase image 17 and/or a wave pattern emitted through the LC phase shift layer 2.

Preferably, an array of LC pixels P_{m,n} is arranged according to a primitive rectangular or square lattice, because this is simpler to arrange to correspond to respective transistors T_{m,n} in rows and columns of the active matrix transistor array 5. However, in general an array of LC pixels P_{m,n} may be arranged according to any one of the five two-dimensional Bravais lattices.

The example shown in FIG. 2 is simply one example of implementing the active matrix transistor array 5 and the LC pixels Pₖ of the LC shift layer. In other examples, the geometry of the one or more planar antennae 3 may differ from the geometry of the active matrix transistor array 5. The active matrix transistor array 5 will be addressed and controlled in the same way, but the transistors T_{m,n} may be connected to LC pixels Pₖ in any order. The capacity to use phase images 17 to store voltage values Vₖ is unaffected by whether or not the arrangement of LC pixels Pₖ corresponds to the arrangement of transistors T_{m,n}, although if the two do not correspond, visualizations of the phase image 17 are unlikely to be as useful for visualizing the output phases.

### First Antenna Assembly

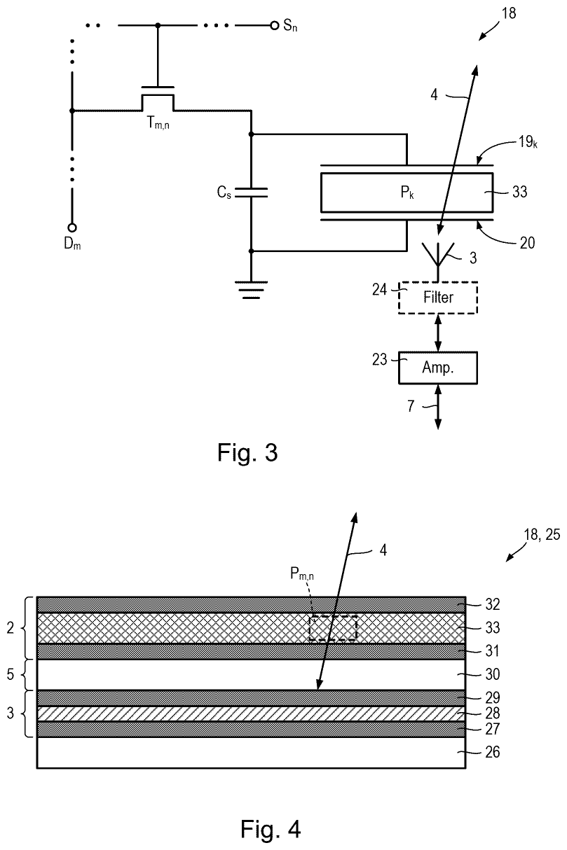

Referring also to FIG. 3, a first exemplary antenna assembly 18 (hereinafter first antenna assembly) is shown.

The first antenna assembly 18 may be used in an implementation of the radio transceiver 1. In the first antenna assembly 18, the one or more planar antennae 3 are electrically separated (isolated) from the LC pixels Pₖ of the LC phase shift layer 2.

The LC phase shift layer 2 takes the form of a layer of liquid crystal material 33 in which each LC pixel Pₖ is defined by a respective LC pixel electrode 19ₖ connected to the ungrounded side of a corresponding storage capacitor Cs of the active matrix transistor array 5. Each LC pixel Pₖ also includes at least part of an LC bias electrode 20. An individual LC bias electrode 20ₖ may be defined corresponding to each LC pixel electrode 19ₖ, or a single LC bias electrode 20 may be common to two or more, or even all, of the LC pixels Pₖ.

The LC pixels Pₖ and corresponding LC pixel electrodes 19ₖ may be arranged in an array corresponding to the transistors T_{m,n} of the active matrix transistor array 5 (as shown in FIG. 2), so that each LC pixel Pₖ may be alternatively referred to as P_{m,n} and each LC pixel electrode 19ₖ as 19_{m,n}.

Electrode layers defining the LC pixel electrodes 19ₖ, 19_{m,n} and the LC bias electrode(s) 20 should be impedance matched to allow passage of the radio signals 4 in the desired frequency range, for example between and including 5 GHz and 300 GHz (or one or more portions thereof).

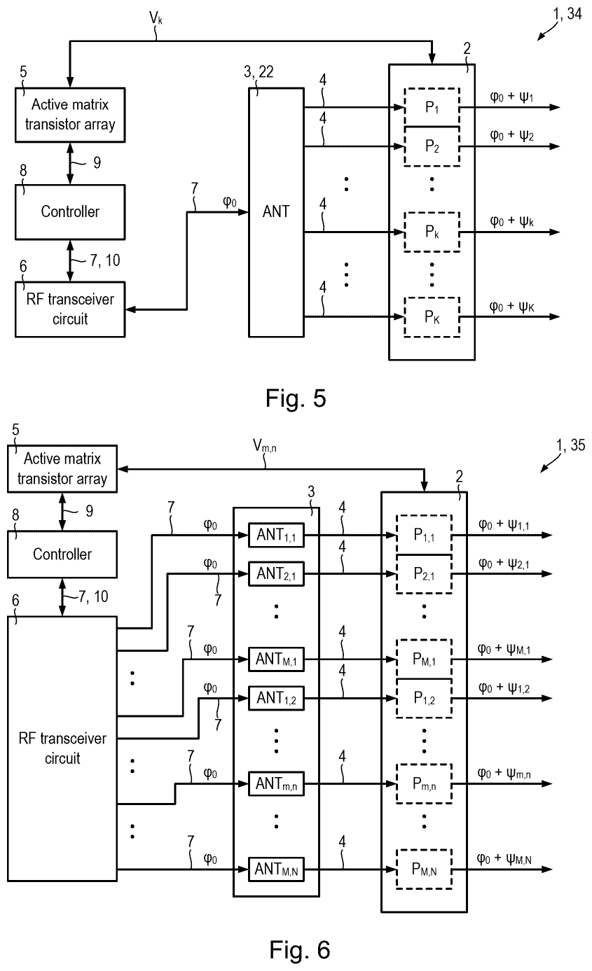

The one or more planar antennae 3 may include any number of individual planar antennae 3, and may even take the form of a single planar antennae 22 (FIG. 5). Each planar antenna 3 is connected to an amplifier 23 forming part of the radio transceiver circuit 6. For transmitting, the amplifier 23 may take the form of a power amplifier. For receiving, the amplifier 23 may take the form of a low-noise amplifier. The connection to a planar antenna 3 may be switchable between a power amplifier and a low-noise amplifier. Optionally, one or more filters 24 may be connected between the radio transceiver circuit 6 and the planar antenna 3. When included, filters 24 may be connected between the planar antennae 3 and respective amplifiers 23 and/or between the amplifiers 23 and the rest of the radio transceiver circuit 6.

In some examples, the amplifier 23 may be separate from the radio transceiver circuit 6 and connected between the radio transceiver circuit 6 and the planar antenna 3.

Referring also to FIG. 4, a schematic cross-section of a first stack-up 25 implementing the first antenna assembly 18 is shown.

The first stack-up 25 includes a substrate 26. The one or more planar antennae 3 are supported on the substrate 26, and include an antenna ground plane layer 27, an antenna dielectric layer 28 and a radiating conductor layer 29. The radiating conductor layer 29 is patterned to define the one or more planar antennae, and the antenna ground plane layer 27 may be a uniform ground plane (continuous conductor layer), or may be patterned to corresponding to the radiating conductor layer 29.

In the first stack-up 25, the active matrix transistor array 5 is integrated into the first antenna assembly 18 in the form of a TFT substrate 30 supporting a TFT active matrix array. For example, the TFT substrate 30 may be formed of glass supporting a thin layer of amorphous silicon within which the transistors T_{m,n} in the form of TFTs are defined. The TFT substrate 30 overlies the one or more planar antennae 3, and is preferably bonded or otherwise secured to the one or more planar antennae 3.

An LC phase shift layer 2 is bonded, or directly deposited, over the TFT substrate 30, and includes an LC pixel electrode layer 31 separated from a LC bias electrode layer 32 by a layer of liquid crystal material 33. The LC pixels Pₖ are arranged as LC pixels P_{m,n} arranged to physically overlie the respective transistors T_{m,n}, and the LC pixel electrode layer 31 defines the LC pixel electrodes 20_{m,n}. Preferably the LC phase shift layer 2 is arranged with the LC pixel electrode layer 31 contacting, or at least closest to, the TFT substrate 31. This may facilitate simplified and/or direct connections between LC pixels P_{m,n} and respective transistors T_{m,n}.

The first stack-up 25 is one example of implementing the first antenna assembly 18, but the first antenna assembly 18 is not limited to the first stack-up 25.

### First Radio Transceiver Configuration

Referring also to FIG. 5, a first radio transceiver configuration 34 (hereinafter “first radio”) is shown.

The first radio 34 is an implementation of the radio transceiver 1. The first radio 34 may use the first antenna assembly 18.

The one or more planar antennae 3 of the first radio 34 take the form of a single planar antenna 22, ANT which underlies and is substantially co-extensive with the plurality of LC pixels P₁, . . . , P_{K} defined in the LC phase shift layer 2. The single planar antenna 19 need not be a uniform or unpatterned antenna, and may be patterned (though all portions are continuously connected).

The radio frequency transceiver circuit 6 drives the single planar antenna 22 with radio frequency (RF) signals 7 having a phase of φ₀. Radio signals 4 emitted from the single planar antenna 22 pass through the LC pixels P₁, . . . , P_{K}, and acquire respective phase shifts ψ₁, . . . , ψ_{K}. The phase shifts ψ₁, . . . , ψ_{K} are controlled so that the radio signals 4 emerge from the LC phase shift layer 2 as a directed beam (corresponding to a direction in which there is constructive interference), instead of a planar wavefront as would be expected in the absence of the LC phase shift layer 2.

The LC pixels P₁, . . . , P_{K} may be arranged as an array of LC pixels P_{m,n} corresponding to respective transistors T_{m,n} of the active matrix transistor array 5 (see FIG. 2).

Although illustrated in relation to transmission of radio signals 4, the first radio 34 may additionally or alternatively receive radio signals 4 from a beamforming direction by the reverse of the process of transmission.

### Second Radio Transceiver Configuration

Referring also to FIG. 6, a second radio transceiver configuration 35 (hereinafter “second radio”) is shown.

The second radio 35 is an implementation of the radio transceiver 1. The second radio 35 may use the first antenna assembly 18. The one or more planar antennae 3 of the second radio 35 take the form of a planar antenna ANT_{m,n} corresponding to each LC pixel P_{m,n}. For example, each planar antenna ANT_{m,n} may be arranged directly underlying (or overlying) the respective LC pixel P_{m,n}, and configured to receive and/or transmit radio signals through the LC pixel P_{m,n}. Both the LC pixels P_{m,n} and the respective planar antennae ANT_{m,n} are arranged in arrays which correspond to the array of transistors T_{m,n} forming the active matrix transistor array 5.

The radio frequency transceiver circuit 6 drives each planar antenna ANT_{m,n} in phase, using radio frequency (RF) signals 7 having a phase of φ₀. Radio signals 4 emitted from the each planar antenna ANT_{m,n} pass through the respective LC pixels P_{m,n}, and acquire a corresponding respective phase shift ψ_{m,n}. The phase shifts ψ_{1,1}, . . . , ψ_{M,N} are controlled so that the radio signals 4 emerge from the LC phase shift layer 2 as a directed beam (corresponding to a direction in which there is constructive interference), instead of a planar wavefront as would be expected in the absence of the LC phase shift layer 2.

Although illustrated in relation to transmission of radio signals 4, the second radio 35 may additionally or alternatively receive radio signals 4 from a beamforming direction by the reverse of the process of transmission.

### Third Radio Transceiver Configuration

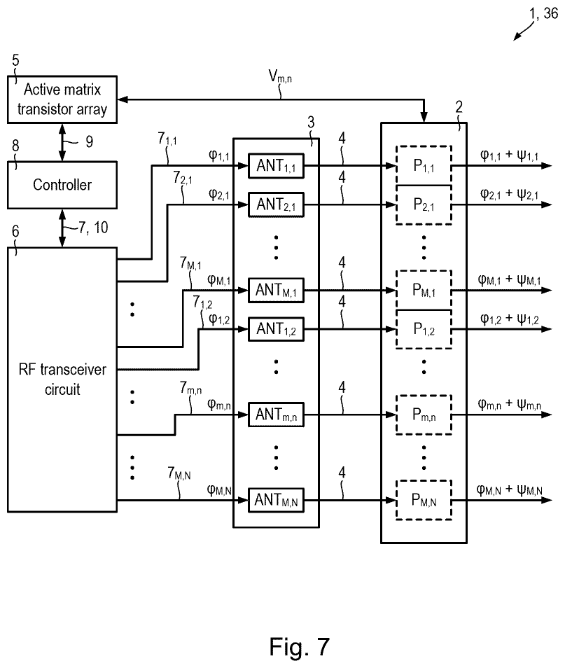

Referring also to FIG. 7, a third radio transceiver configuration 36 (hereinafter “third radio”) is shown.

The third radio 36 is an implementation of the radio transceiver 1. The third radio 36 may use the first antenna assembly 18. The third radio 36 is the same as the second radio 35, except that instead of driving all the antennae ANT_{m,n} coherently, the radio frequency transceiver circuit 6 is configured to transmit to and/or receive from each planar antenna ANT_{m,n} using respective RF electrical signal 7_{m,n} having a corresponding phase φ_{m,n}. Each phase φ_{m,n} corresponds to a phase shift relative to a base signal φ₀, which without loss of generality may be assumed to correspond to one of the phases φ_{m,n}, for example φ_{1,1}. Across the entire array, two or more phases φ_{m,n} may be equal or equivalent, depending on the beamforming direction.

The radio signals 4 emerging from the LC phase shift layer 2 have phases which are a sum of the phases φ_{m,n} used to drive the antennae ANT_{m,n} and the phase shifts V_{m,n} imparted by passage through the LC pixels P_{m,n}. This two-stage (or “hybrid”) beam forming, may allow a beam to be formed to a wider range of beamforming angles than would otherwise be possible using a given thickness t of the LC material layer 33 of the LC phase shift layer 2. Additionally or alternatively, two-stage beam forming may reduce a required thickness t of the LC phase shift layer 2. This may help to reduce the magnitude of voltages which need to be applied to obtain a given electric field.

It is complex to provide a large number of tunable phases φ_{m,n} of electrical signals 7_{m,n} with fine precision. For example, a transmission line to a given antenna ANT_{m,n} may be switchable (for example using additional transistors belonging to, or formed on the same substrate as, the transistors T_{m,n}) between two or more passive phase shift elements/structures, each of which may correspond to a pre-set beamforming direction. Fine control of the beamforming direction may then be provided by the further phase shifts V_{m,n} imparted by passage through the LC pixels P_{m,n}.

In some examples, a group of antennae ANT_{m,n} may be driven in phase with one another. For example, a square or rectangular patch of the wider array. In such an example, the total number of distinct phases φ_{m,n} which need to be driven may be substantially less than K. For example, a 12 by 12 array of antennae ANT_{m,n} may be driven in square 4 by 4 groups, reducing a number of distinct RF signals 7_{m,n} required from 144 to only 9. Each group may be driven with a phase φ corresponding to an average phase for the corresponding region, which may then be adjusted up or down as needed by the additional phase shifts V_{m,n} imparted by passage through the LC pixels P_{m,n}.

This two-stage combination of coarse beamforming in the electronics combined with fine beamforming using the LC phase shift layer 2, may allow a beam to be formed to a wider range of beamforming angles than would be possible using a given thickness t of the LC material layer 33 of the LC phase shift layer 2, whilst minimizing the complexity of the electronics of the RF transceiver circuit 6. Additionally or alternatively, two-stage beam forming may reduce a required thickness t of the LC phase shift layer 2 and/or may reduce the magnitude of voltages which need to be applied to obtain a given electric field.

### Fourth Radio Transceiver Configuration

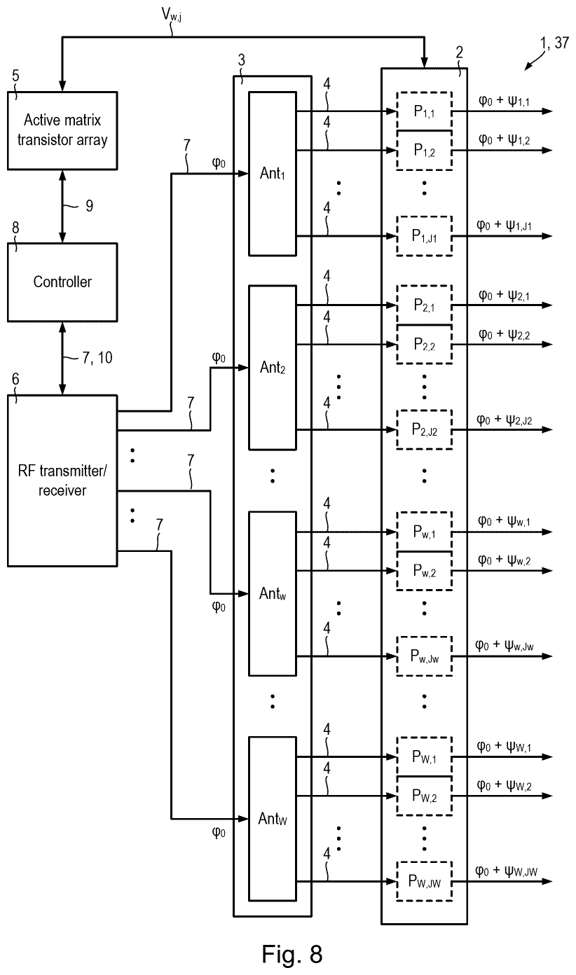

Referring also to FIG. 8, a fourth radio transceiver configuration 37 (hereinafter “fourth radio”) is shown.

The fourth radio 37 is an implementation of the radio transceiver 1. The fourth radio 37 may use the first antenna assembly 18. The one or more planar antennae 3 of the second radio 35 take the form of a number W of planar antennae ANT₁, . . . , ANT_{w}, . . . , ANT_{w}, in which ANT_{w} denotes the w^{th} of W antennae. The number W is greater than or equal to 2, and less than the total number K of LC pixels Pₖ, i.e. 2≤W<K. Each of the planar antennae ANT₁, . . . . ANT_{w}, underlies (or overlies) the LC pixels Pₖ, and the LC phase shift layer 2 wholly overlaps each planar antenna ANT₁, . . . , ANT_{w}, so that radio signals to and/or from an antennae ANT_{w} pass through at least one LC pixel Pₖ.

In other words, each antenna ANT_{w} transmits and/or receives through a group of one or more corresponding LC pixels Pₖ. Denoting the number of LC pixels Pₖ corresponding to the w^{th} antenna ANT_{w} as Jw, then:

$$K = {\sum }_{w = 1}^{W} Jw \qquad ( 5 )$$

Let the j^{th} of Jw LC pixels corresponding to the w^{th} antenna ANT_{w} be denoted P_{w,j}.

The radio frequency transceiver circuit 6 drives each planar antenna ANT_{w} in phase, using radio frequency (RF) signals 7 having a phase of φ₀. Radio signals 4 emitted from the each planar antenna ANT_{w} pass through the respective LC pixels P_{w,1}, . . . , P_{w,Jw} and acquire a corresponding phase shifts ψ_{w,1}, . . . , ψ_{w,Jw}. The phase shifts ψ_{1,1}, . . . , ψ_{w,Jw} are controlled so that the radio signals 4 emerge from the LC phase shift layer 2 as a directed beam (corresponding to a direction in which there is constructive interference), instead of a planar wavefront as would be expected in the absence of the LC phase shift layer 2.

In some examples, the LC pixels P_{w,Jw} are arranged in an array corresponding to the active matrix transistor array 5 (see FIG. 2) and each planar antenna ANT_{w} may correspond to a square or rectangular group of the LC pixels P_{w,Jw}. Alternatively, each planer antenna ANT_{w} may correspond to a band or strip, for example, one or more rows/columns of LC pixels P_{w,Jw}.

Although illustrated in relation to transmission of radio signals 4, the fourth radio 37 may additionally or alternatively receive radio signals 4 from a beamforming direction by the reverse of the process of transmission.

### Fifth Radio Transceiver Configuration

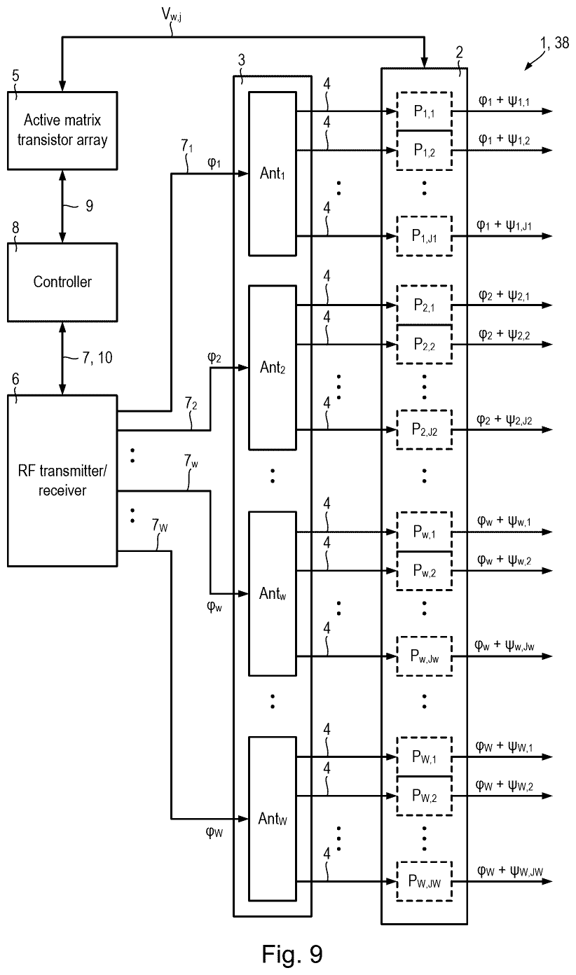

Referring also to FIG. 9, a fifth radio transceiver configuration 38 (hereinafter “fifth radio”) is shown.

The fifth radio 38 is an implementation of the radio transceiver 1. The fifth radio 38 may use the first antenna assembly 18. The fifth radio 38 is the same as the fourth radio 37, except that instead of driving all the planar antennae ANT₁, . . . , ANT_{w} in phase, the radio frequency transceiver circuit 6 is configured to transmit to and/or receive from each planar antenna ANT_{w} using respective RF electrical signals 7w having a corresponding phase φ_{w}. Each phase φ_{w} corresponds to a phase shift relative to a base signal φ₀, which without loss of generality may be assumed to correspond to one of the phases φ_{w}, for example φ₁. Across the entire array, two or more phases ow may be equal or equivalent, depending on a desired beamforming direction.

The radio signals 4 emerging from the LC phase shift layer 2 have phases which are sums of the phases φ_{w} used to drive the antennae ANT_{m,n} and the phase shifts ψ_{w,1}, . . . , ψ_{w,Jw} imparted by passage through the LC pixels P_{w,1}, . . . , P_{w,Jw}. This two-phase beam forming, may allow a beam to be formed to a wider range of beamforming angles than would be possible using a given thickness t of the LC material layer 33 of the LC phase shift layer 2. Additionally or alternatively, two-stage beam forming may reduce a required thickness t of the LC phase shift layer 2 and/or reduce the magnitude of voltages which need to be applied to obtain a given electric field.

When the LC pixels P_{w,Jw} are arranged in an array corresponding to the active matrix transistor array 5 (see FIG. 2) and when each planar antenna ANT_{w} corresponds to a square or rectangular group of the LC pixels P_{w,Jw}, the previously described two-stage beamforming may be carried out. For example, coarse beamforming may be provided by the phases φ₁, . . . , φ_{w} of the RF electrical signals 7₁, . . . , 7_{w}, whilst fine control of the beamforming direction is then provided by the further phase shifts ψ_{w,jw} imparted by passage through the LC pixels P_{w,jw}.

### Example Antenna Shapes

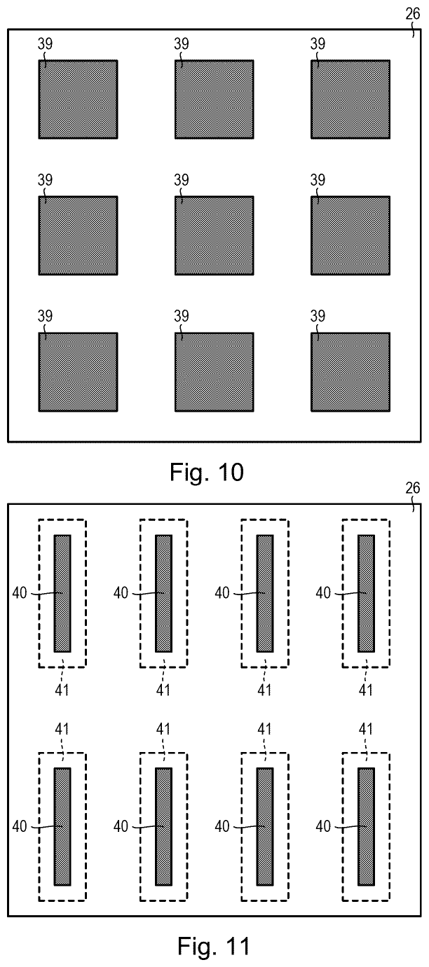

Referring also to FIG. 10, a first type of planar antennae 39 (hereinafter “first planar antennae”) are shown.

The first planar antennae 39 take the form of square conductive regions, each of which provides a radiating conductor of an antenna. For example, the first planar antennae may be patterned into the radiating conductor layer 29. The antenna ground plane (for example antenna ground plane layer 27) may be patterned the same way and aligned with the first planar antennae 39. Alternatively, the antenna ground plane may take the form of a single patterned (e.g. mesh) or unpatterned conductive region.

A corresponding LC pixel Pₖ is positioned to overlap each of the first planar antennae 39, and preferably has a slightly larger area.

Although shown in a square array, the first planar antennae 39 may be organized according to any (lattice) type or shape of array. Although a three by three array is shown in FIG. 10, an array of the first planar antennae 39 may include any number of rows and/or columns.

Referring also to FIG. 11, a second type of planar antennae 40 (hereinafter “second planar antennae”) are shown.

The second type of planar antennae 40 are the same as the first type 39, except that the second planar antennae 39 take the form of rectangular conductive regions having a long axis and a short axis. Projected outlines 41 of corresponding overlying or underlying LC pixels Pₖ are shown using dashed lines.

Although shown in a rectangular array, the second planar antennae 40 may be organized according to any (lattice) type or shape of array. Although a three by three array is shown in FIG. 11, an array of the second planar antennae 40 may include any number of rows and/or columns.

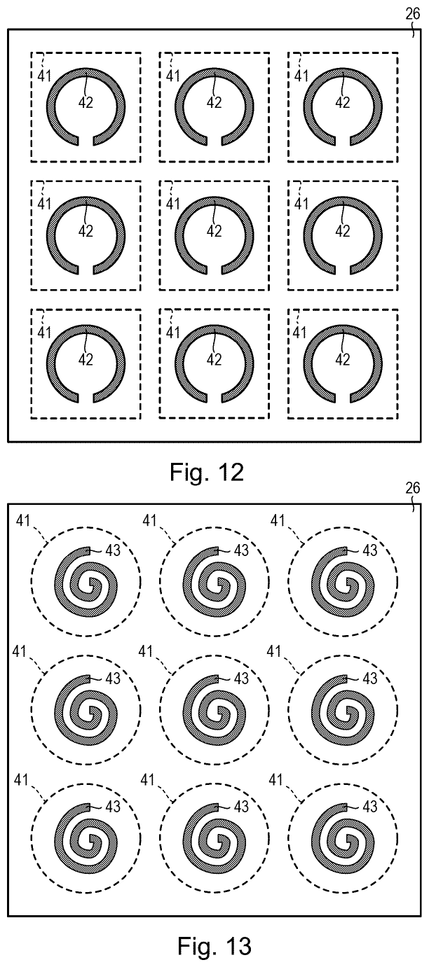

Referring also to FIG. 12, a third type of planar antennae 42 (hereinafter “third planar antennae”) are shown.

The third type of planar antennae 42 are the same as the first or second types 39, 40, except that the third planar antennae 42 take the form of ring (or “loop”) antennae. Projected outlines 41 of corresponding overlying or underlying LC pixels Pₖ are shown using dashed lines.

Although shown in a square array, the third planar antennae 42 may be organized according to any (lattice) type or shape of array. Although a three by three array is shown in FIG. 12, an array of the third planar antennae 42 may include any number of rows and/or columns.

Referring also to FIG. 13, a fourth type of planar antennae 43 (hereinafter “third planar antennae”) are shown.

The fourth type of planar antenna 43 is the same as the first, second or third types 39, 40, 42, except that the fourth planar antennae 43 take the form of spiral antennae. Projected outlines 41 of corresponding overlying or underlying LC pixels Pₖ are shown using dashed lines. Unlike FIGS. 11 and 12, the projected outlines 41 of corresponding LC pixels Pₖ are circular in FIG. 13. The particular shape of corresponding LC pixels Pₖ is not important for any type of planar antenna 39, 40, 42, 43, provided that a projected outline 41 encloses the corresponding planar antenna 3, 39, 40, 42, 43. For example, square LC pixels Pₖ could be used instead in FIG. 13, or circular LC pixels Pₖ may be used instead in FIGS. 11 and/or 12.

Although shown in a square array, the fourth planar antennae 43 may be organized according to any (lattice) type or shape of array. Although a three by three array is shown in FIG. 13 an array of the fourth planar antennae 43 may include any number of rows and/or columns.

Referring also to FIG. 14, a fifth type of planar antennae 44 (hereinafter “fifth planar antennae”) are shown.

The fifth type of planar antenna 44 is the same as the first to fourth types 39, 40, 42, 43 except that the fifth planar antennae 44 take the form of Vivaldi antennae. Vivaldi antennae are directional, and each fifth planar antennae 44 emits a radiation pattern with a main lobe centered in a direction parallel to an emission direction 45. Projected outlines 41 of corresponding overlying or underlying LC pixels Pₖ are shown using dashed lines.

Although shown in a rectangular array, the fifth planar antennae 44 may be organized according to any (lattice) type or shape of array. Although a three by three array is shown in FIG. 14, an array of the fifth planar antennae 44 may include any number of rows and/or columns.

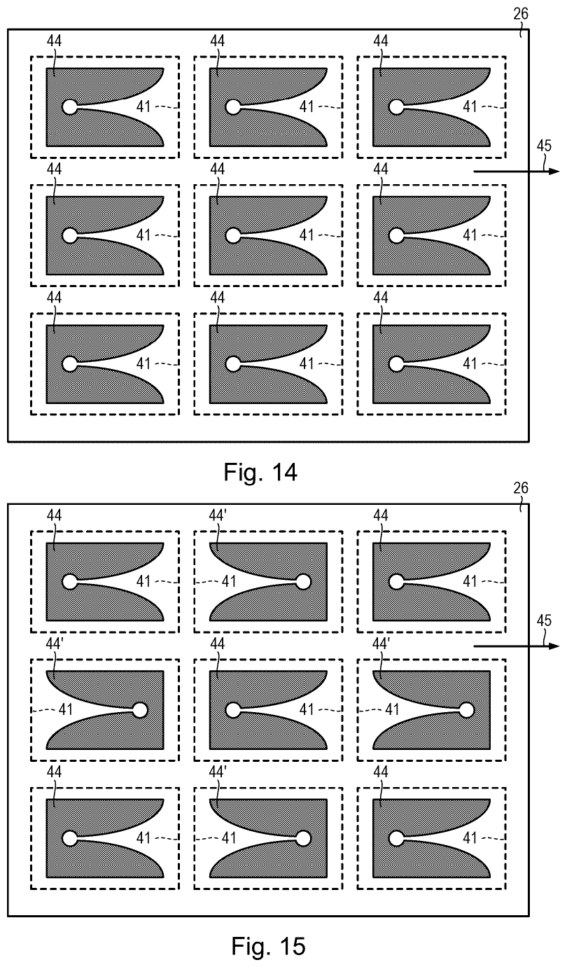

Referring also to FIG. 15, an alternative arrangement of fifth planar antennae 44 (hereinafter “fifth planar antennae”) is shown.

In particular, when using in-plane directional planar antennae such as the fifth planar antennae 44, they do not all need to be orientated in the same direction. In FIG. 15, some fifth planar antennae 44 are oriented to emit parallel to the emission direction 45 whilst other fifth planar antennae 44′ are oriented to emit anti-parallel. The two orientations are arranged in interpenetrating lattices (rectangular, and centered with a two antenna motif. Motif herein has the meaning known from crystallography and other types of repeating/tessellated patterns, but referring here to an arrangement of antennae relative to a lattice point). The fifth planar antennae 44 are not limited to being parallel/anti-parallel, and a given array may include fifth planar antennae 44 orientated in any direction, arranged according to a lattice with a motif including any number of antennae.

The examples of the first to fifth planar antennae 39, 40, 42, 43, 44 are not-exhaustive, and in general the one or more planar antennae 3 may include any suitable type of planar antenna, or may include combinations of two or more types of planar antenna.

### Second Antenna Assembly

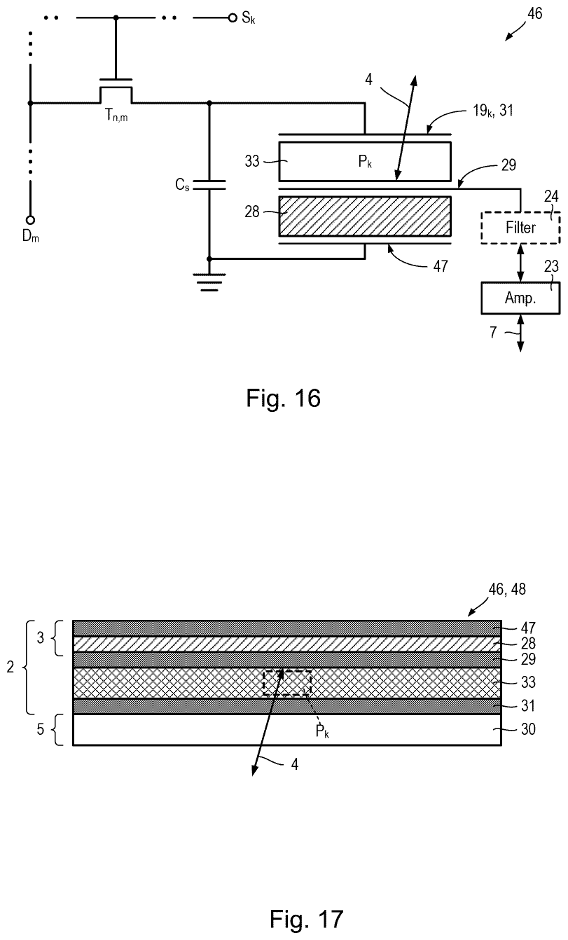

Referring also to FIG. 16, a second exemplary antenna assembly 46 (hereinafter second antenna assembly) is shown.

The second antenna assembly 46 may be used in an implementation of the radio transceiver 1, and may replace the first antenna assembly 18 in any radio transceiver 1 including, but not limited to, the first to fifth radios 34, 35, 36, 37, 38.

In the second antenna assembly 46, the one or more planar antennae 3 are integrated with the LC pixels Pₖ of the LC phase shift layer 2 in that they share a common ground plane.

A common ground conductor layer 47 (or first conductor layer) provides a ground layer for the (or each) LC pixel Pₖ, similarly to the LC bias electrode(s) of the first antenna assembly 18. A radiating conductor layer 29 (or second conductor layer) is separated from the common ground conductor layer 47 by an antenna dielectric layer 28. The radiating conductor layer 29 is patterned to provide radiating conductors of the one or more planar antennae 3. The common ground conductor layer 47 also provides the ground layer for the one or more planar antennae. A LC pixel electrode layer 31 (or third conductor layer) is separated from the radiating conductor layer 29 by a layer of liquid crystal material 33. The LC pixel electrode layer patterned is patterned to provide LC pixel electrodes 19ₖ defining respective LC pixels Pₖ of the LC phase shift layer 3.

The common ground conductor layer 47 may be a uniform, unpatterned electrode. Alternatively, the common ground conductor layer 47 may be patterned to form a number of separate electrodes.

The LC pixels Pₖ and corresponding LC pixel electrodes 19ₖ may be arranged in an array corresponding to the transistors T_{m,n} of the active matrix transistor array 5 (as shown in FIG. 2), so that each LC pixel Pₖ may be alternatively referred to as P_{m,n} and each LC pixel electrode 19ₖ as 19_{m,n}.

The LC pixel electrode layer 31 defining the LC pixel electrodes 19ₖ, 19_{m,n} should be impedance matched to allow passage of the radio signals 4 in the desired frequency range, for example between and including 5 GHz and 300 GHz (or one or more portions thereof).

In the same way as the first antenna assembly 18, the one or more planar antennae 3 may include any number of planar antennae 3. Each planar antenna 3 is connected to the radio transceiver circuit 6 in the same way as the first antenna assembly 18, including optional filters 24 and/or amplifiers 23 (internal or external to the radio transceiver circuit 6).

Compared to the first antenna assembly 18, the structure of the second antenna assembly is simplified using the common ground conductor layer 47 instead of both an antenna ground plane layer 27 and a LC bias electrode layer 31. Additionally, whilst the LC pixel electrode layer 31 defining the LC pixel electrodes 19ₖ, 19_{m,n} should still be impedance matched to allow passage of the radio signals 4, radio signals 4 are emitted through a smaller number of impedance matched layers, which may improve output signal strength.

Referring also to FIG. 17, a schematic cross-section of a second stack-up 48 implementing the second antenna assembly 46 is shown.

A TFT substrate 30 supports the active matrix transistor array 5. The LC pixel electrode layer 31 is supported, or formed directly on, the active matrix transistor array 5. This may facilitate simplified and/or direct connections between LC pixels P_{m,n} and respective transistors T_{m,n}. The radiating conductor layer 29 is separated from the LC pixel electrode layer 31 by the layer of LC material 33. On the opposite side, the radiating conductor layer 29 is separated from the common ground plane conductor layer 47 by the antenna dielectric layer 28. A substrate 26 may be omitted, with mechanical support instead provided by the TFT substrate 30.

The one or more planar antennae 3 are defined between the common ground plane layer 48 and the radiating conductor layer 29. The LC phase shift layer 2 is defined between the common ground plane layer 48 and the LC pixel electrode layer 31. In this way, the one or more planar antennae 3 and the LC phase shift layer 2 are not separate layers, because the one or more planar antennae 3 lie within the LC phase shift layer 2.

The second stack-up 48 is one example of implementing the second antenna assembly 46, but the second antenna assembly 46 is not limited to the second stack-up 48.

### Third Antenna Assembly

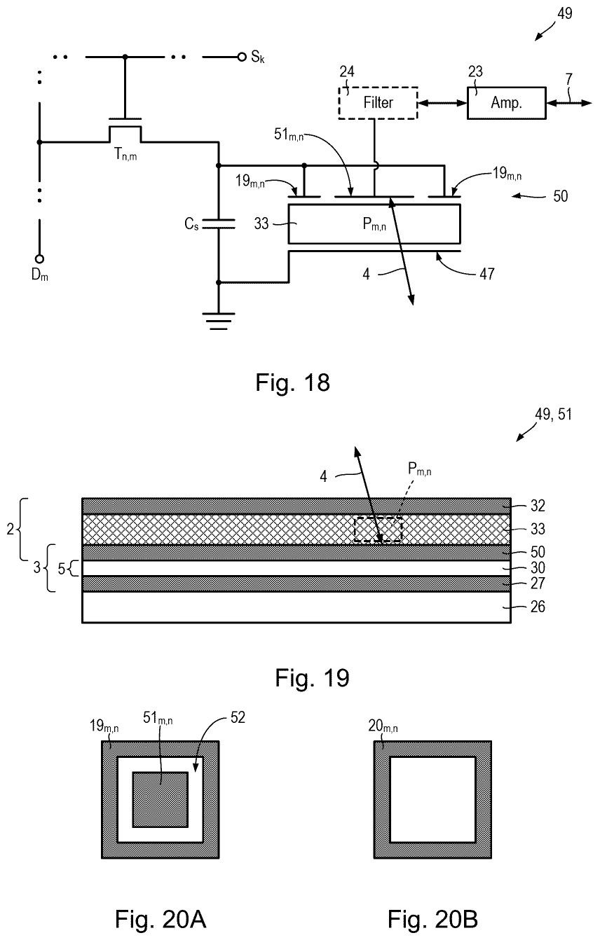

Referring also to FIG. 18, a third exemplary antenna assembly 49 (hereinafter third antenna assembly) is shown.

The third antenna assembly 49 may be used in an implementation of the radio transceiver 1, and may replace the first antenna assembly 18 in any radio transceiver 1 including, but not limited to, the first to fifth radios 34, 35, 36, 37, 38.

In the third antenna assembly 49, LC pixels Pₖ and corresponding LC pixel electrodes 19ₖ are arranged in an array corresponding to the transistors T_{m,n} of the active matrix transistor array 5 (as shown in FIG. 2), so that each LC pixel Pₖ is referred to as P_{m,n} and each LC pixel electrode 19ₖ as 19_{m,n}.

The planar antennae 3 are integrated with the LC pixels P_{m,n} of the LC phase shift layer 2 in that LC pixel electrodes 19_{m,n} are patterned from the same conductive layer 50 (fourth conductive later) as antenna electrodes 51_{m,n} providing radiating conductors of respective planar antennae 3. The LC pixel electrodes 19_{m,n} are interspersed with the antenna electrodes 51_{m,n}. A LC bias electrode layer 32 (fifth conductor layer) is separated from the conductor layer 50 by a layer of liquid crystal material 33, and provide a ground layer for the LC pixels P_{m,n}. The antenna ground plane layer 27 is provided separately (see FIG. 19). The LC bias electrode layer 32 is impedance matched to allow passage of the radio signals 4 in the desired frequency range, for example between and including 5 GHz and 300 GHz (or one or more portions thereof), so as to be configured to minimize attenuation of radio signals 4 received by and/or transmitted from the planar antennae 3 defined by the antenna electrodes 51_{m,n}.

Referring also to FIG. 19, a schematic cross-section of a third stack-up 51 implementing the third antenna assembly 49 is shown.

A substrate 26 supports the antenna ground plane layer 27 (sixth conductor layer). A TFT substrate 30 including the active matrix transistor array is disposed over the antenna ground plane layer 27. The conductor layer 50 defining the LC pixel electrodes 19_{m,n} and the antenna electrodes 51_{m,n} providing radiating conductors is disposed over the TFT substrate 30. The TFT substrate 30 serves as an antenna dielectric, and is also located for simple and direct connections to the LC pixel electrodes 19_{m,n}. The LC bias electrode layer 32 is separated from the conductive layer 50 by a layer of LC material 33. If the TFT substrate 30 is capable of providing mechanical support for the other layers, the substrate 26 may be omitted. TFTs of the active matrix transistor array 5 providing transistors T_{m,n} may be arranged so as to avoid overlapping with any antenna electrodes 51_{m,n}.

The one or more planar antennae 3 are defined between the antenna ground plane layer 27 and the conductive layer 50. The LC phase shift layer 2 is defined between the LC bias electrode layer 32 and the conductive layer 50. In this way, the one or more planar antennae 3 and the LC phase shift layer 2 are not separate layers, because the conductor layer 50 belongs to both.

Referring also to FIGS. 20A and 20B, an example configuration of LC pixel electrodes 19_{m,n}, antenna electrodes 51_{m,n} and LC bias electrodes 20_{m,n} is shown.

Referring in particular to FIG. 20A, within the conductive layer 50, each antenna electrode 51_{m,n} may be surrounded by a corresponding annular LC pixel electrode 19_{m,n}, separated by a gap 52. The antenna electrode 51_{m,n} may be connected using a via to another layer, or the LC pixel electrode 19_{m,n} may include a small gap sized to permit routing a conductive trace to the antenna electrode 51_{m,n}.

Referring in particular to FIG. 20B, within the LC bias electrode layer 32, a LC bias electrode 20_{m,n} is aligned with and has the same shape as the annular LC pixel electrode 19_{m,n}, and the two electrodes 19_{m,n}, 20_{m,n} are co-extensive. The antenna electrode 51_{m,n} may emit and/or receive radio signals 4 through the region enclosed by the annular LC bias electrode 20_{m,n}.

Alternatively, the LC bias electrode layer 32 may take the form of a single conductor having a mesh structure with spacing between elements forming the mesh configured to minimize attenuation of radio signals 4.

In a modification (not shown), instead of the TFT substrate 30 serving as antenna dielectric, the substrate 26 may be omitted, and the antenna ground plane 27 may be moved to the opposite side of the TFT substrate 30 to that shown in FIG. 19. In such an implementation, the antenna ground plane 27 is separated from the conductor layer 50 by an antenna dielectric layer 28 (not shown in FIG. 19, but shown elsewhere).

In a further modification (not shown) of the third antenna assembly 49, the separate antenna ground place later 27 may be omitted, and the LC bias electrode layer 32 may also provide a ground plane of the planar antennae 3.

The third stack-up 51 is one example of implementing the third antenna assembly 49, but the third antenna assembly 49 is not limited to the third stack-up 51.

### Fourth Antenna Assembly

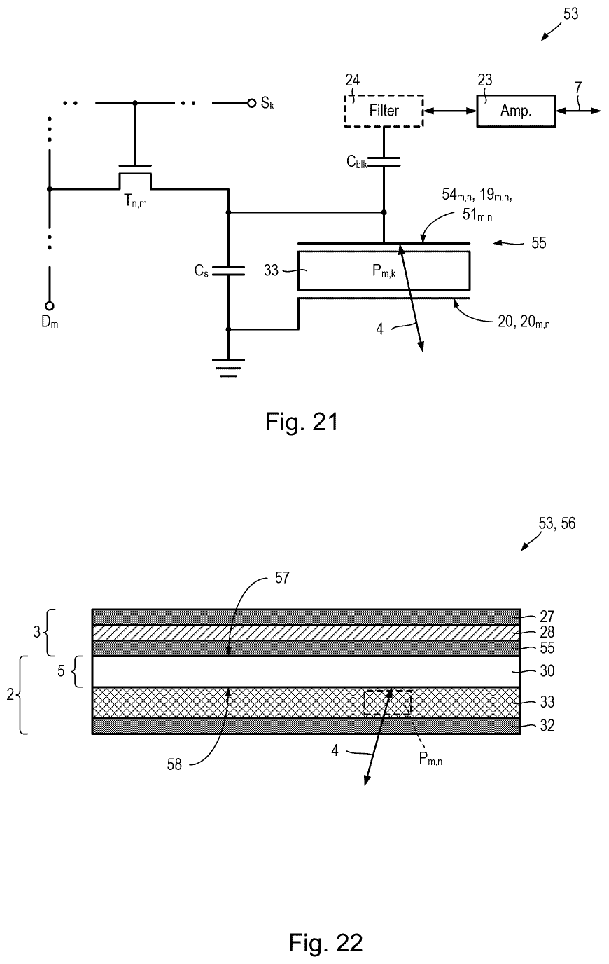

Referring also to FIG. 21, a fourth exemplary antenna assembly 53 (hereinafter fourth antenna assembly) is shown.

The fourth antenna assembly 53 may be used in an implementation of the radio transceiver 1, and may replace the first antenna assembly 18 in any radio transceiver 1 including, but not limited to, the first to fifth radios 34, 35, 36, 37, 38.

In the fourth antenna assembly 53, LC pixels Pₖ and corresponding LC pixel electrodes 19ₖ are arranged in an array corresponding to the transistors T_{m,n} of the active matrix transistor array 5 (as shown in FIG. 2), so that each LC pixel Pₖ is referred to as P_{m,n} and each LC pixel electrode 19ₖ as 19_{m,n}.

In the fourth antenna assembly 53, the planar antennae 3 are integrated with the LC pixels P_{m,n} of the LC phase shift layer 2 in that each LC pixel electrodes 19_{m,n} and the respective antenna electrode 52_{m,n} are provided by the same, common signal electrode 54_{m,n}, patterned from a common signal electrode layer 55 (seventh conductor layer).

A LC bias electrode layer 32 (eighth conductor layer) defining one or more LC bias electrodes 20 is separated from the common signal electrode layer 55 by a layer of LC material 33. The antenna ground plane layer 27 is provide separately (see FIG. 22). The LC bias electrode layer 32 is impedance matched to allow passage of the radio signals 4 in the desired frequency range, for example between and including 5 GHz and 300 GHz (or one or more portions thereof), so as to be configured to minimize attenuation of radio signals 4 received by and/or transmitted from the planar antennae 3 defined by the common signal electrodes 54_{m,n}.

The connection between each common signal electrode 54_{m,n} and the RF transceiver circuit 5 includes a blocking capacitance C_{blk}, so that DC and low frequency components are not coupled between the active matrix transistor array 5 and the RF transceiver circuit. In any event, attenuated low frequency components may be removed by filtering (e.g. using one or more filters 24). The frequency range of 5 GHz and above is significantly outside the bandwidth at which most liquid crystal materials are able to respond to an electric field, and hence the application of RF signals 7 should not affect the LC pixel P_{m,n}, because any net DC component of the RF signal will also be blocked by the capacitance C_{blk}.

The LC bias electrode layer 32 should be impedance matched to permit passage of radio signals 4 within the ranges of frequencies described hereinbefore. The LC bias electrode layer 32 may take the form of a single conductor having a mesh structure with spacing's configured to minimize attenuation of radio signals 4. Alternatively, the LC bias electrode layer 32 may be patterned into a number of LC bias electrodes 20, for example one LC bias electrode 20_{m,n} corresponding to each LC pixel electrode 19_{m,n}. In other examples, the LC bias electrode layer 32 may be patterned as the inverse of the common signal electrode layer 55, so that each LC pixel electrode 19_{m,n} coincides with a gap in the LC bias electrode layer 32.

Referring also to FIG. 22, a schematic cross-section of a fourth stack-up 56 implementing the fourth antenna assembly 53 is shown.

A TFT substrate 30 has a first surface 57 and a second surface 58, and provides the active matrix transistor array 5. A layer of LC material 33 is provided over the second surface 58, and a LC bias electrode layer 32 is disposed over the opposite side of the layer of LC material 33. The common signal electrode layer 55 is disposed over (or formed directly on) the first surface 57. An antenna ground plane layer 27 (ninth conductor layer) is separated from the common signal electrode layer 55 by an antenna dielectric layer 28.

The one or more planar antennae 3 are defined between the antenna ground plane layer 27 and the common signal electrode layer 55. The LC phase shift layer 2 is defined between the LC bias electrode layer 32 and the common signal electrode layer 55. In this way, the one or more planar antennae 3 and the LC phase shift layer 2 are not separate layers, because the common signal electrode layer 55 belongs to both.

In a modification (not shown) of the fourth antenna assembly 53, the antenna ground plane 27 and antenna dielectric 28 layers may be omitted and the LC bias electrode layer 32 may also provide the ground plane for the planar antennae 3.

The fourth stack-up 56 is one example of implementing the fourth antenna assembly 53, but the fourth antenna assembly 53 is not limited to the fourth stack-up 56.

### Fifth Antenna Assembly

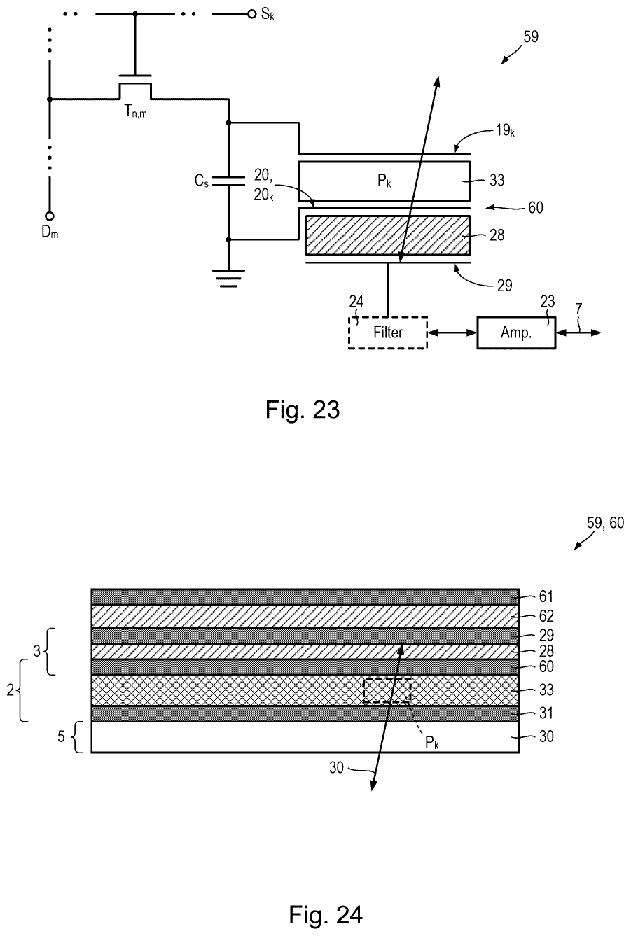

Referring also to FIG. 23, a fifth exemplary antenna assembly 59 (hereinafter fifth antenna assembly) is shown.

The fifth antenna assembly 59 may be used in an implementation of the radio transceiver 1, and may replace the first antenna assembly 18 in any radio transceiver 1 including, but not limited to, the first to fifth radios 34, 35, 36, 37, 38.

In the fifth antenna assembly 59, the one or more planar antennae 3 are integrated with the LC pixels Pₖ of the LC phase shift layer 2 in that they share a common ground plane.

A common ground conductor layer 60 (or eleventh conductor layer) provides a ground layer for the (or each) LC pixel Pₖ, similarly to the LC bias electrode(s) 20 of the first antenna assembly 18. The common ground conductor layer 60 also provides an antenna ground layer 27 for the planar antennae 3. The common ground conductor layer 60 is sandwiched between an antenna dielectric layer 28 and a layer of LC material 33. A radiating conductor layer 29 (or tenth conductor layer) is separated from the common ground conductor layer 60 by the antenna dielectric layer 28. The radiating conductor layer 29 is patterned to provide radiating conductors of the one or more planar antennae 3, and may include a single radiating conductor, or may be separated into two or more distinct antenna electrode 51. A LC pixel electrode layer 31 (or twelfth conductor layer) is separated from the common ground conductor layer 60 by a layer of liquid crystal material 33. The LC pixel electrode layer 31 patterned is patterned to provide LC pixel electrodes 19ₖ defining respective LC pixels Pₖ of the LC phase shift layer 3.

The common ground conductor layer 60 and the LC pixel electrode layer 31 are impedance matched to allow passage of the radio signals 4 in the desired frequency range, for example between and including 5 GHz and 300 GHz (or one or more portions thereof), so as to be configured to minimize attenuation of radio signals 4 received by and/or transmitted from the planar antennae 3. The common ground conductor layer 60 may take the form of a single conductor having a mesh structure with spacing's configured to minimize attenuation of radio signals 4. Alternatively, the common ground conductor layer 60 may be patterned into a number of LC bias electrodes 20, for example one LC bias electrode 20_{m,n} corresponding to each LC pixel electrode 19_{m,n}.

The LC pixels Pₖ and corresponding LC pixel electrodes 19ₖ may be arranged in an array corresponding to the transistors T_{m,n} of the active matrix transistor array 5 (as shown in FIG. 2), so that each LC pixel Pₖ may be alternatively referred to as P_{m,n} and each LC pixel electrode 19ₖ as 19_{m,n}.

Referring also to FIG. 24, a schematic cross-section of a fifth stack-up 60 implementing the third antenna assembly 49 is shown.

A TFT substrate 30 provides the active matrix transistor array 5. The LC pixel electrode layer 31 is supported on the TFT substrate 30. The common ground conductor layer 60 is separated from the LC pixel electrode layer 31 by the layer of LC material 33, and sandwiched between the layer of LC material 33 and the antenna dielectric layer 28. The radiating conductor layer 29 is separated from the common ground conductor layer 60 by the antenna dielectric layer 28.

The one or more planar antennae 3 are defined between the common ground conductor layer 60 and the radiating conductor layer 29. The LC phase shift layer 2 is defined between the common ground conductor layer 60 and the LC pixel electrode layer 31. In this way, the one or more planar antennae 3 and the LC phase shift layer 2 are not separate layers, because the common ground conductor layer 60 belongs to both.

Optionally, emission and/or reception of radio signal 4 from the surface of the radiating conductor layer 29 facing away from LC material layer 33 may be suppressed using an optional, grounded screening layer 61, separated from the radiating conductor layer 29 by an optional additional dielectric layer 62. If required, the optional screening layer 61 may be included in any other stack-up and/or antenna assembly described herein, to reduce or even prevent emission and/or reception of radio signals 4 which do not pass through any LC pixels Pₖ.

The fifth stack-up 60 is one example of implementing the fifth antenna assembly 59, but the fifth antenna assembly 59 is not limited to the fifth stack-up 60.

### Modifications

It will be appreciated that many modifications may be made to the embodiments hereinbefore described. Such modifications may involve equivalent and other features which are already known in the design, manufacture and use of radio transceivers, and which may be used instead of or in addition to features already described herein. Features of one embodiment may be replaced or supplemented by features of another embodiment. For example, features of one radio transceiver be replaced or supplemented by features of other wireless transceivers and/or features of one antenna arrangement may be replaced or supplemented by features of other antenna arrangements.

Although claims have been formulated in this application to particular combinations of features, it should be understood that the scope of the disclosure of the present disclosure also includes any novel features or any novel combination of features disclosed herein either explicitly or implicitly or any generalization thereof, whether or not it relates to the same present disclosure as presently claimed in any claim and whether or not it mitigates any or all of the same technical problems as does the present disclosure. The applicant hereby gives notice that new claims may be formulated to such features and/or combinations of such features during the prosecution of the present application or of any further application derived therefrom.

1. A radio comprising:
a liquid crystal (LC) phase shift layer comprising a plurality of individually addressable LC pixels, wherein a path length of each corresponding LC pixel of the plurality of individually addressable LC pixels varies as a function of a voltage applied across the corresponding LC pixel;
one or more planar antennae, each planar antenna of the one or more planar antennae being arranged to at least one of receive or transmit radio signals through the LC phase shift layer;
an active matrix transistor array, each transistor of the active matrix transistor array configured to control a corresponding voltage across a corresponding storage capacitor, wherein each storage capacitor is connected across a respective LC pixel of the plurality of individually addressable LC pixels;
a radio frequency transceiver circuit connected to the one or more planar antennae; and
a controller configured to perform beamforming of corresponding radio signals the at least one of received by or transmitted from the one or more planar antennae by controlling the active matrix transistor array to set the path length for each of the plurality of individually addressable LC pixels.

2. The radio of claim 1, wherein the active matrix transistor array comprises thin-film transistors.

3. The radio of claim 1, wherein the plurality of individually addressable LC pixels are arranged to form an LC pixel array.

4. The radio of claim 1 according to, configured to relay or re-broadcast received radio signals.

5. The radio of claim 1 according to, wherein:
the one or more planar antennae form a single planar antenna which underlies and is co-extensive with the plurality of individually addressable LC pixels; and
the beamforming of the radio signals the at least one of received by or transmitted from the single planar antenna arises from phase shifts introduced by the LC phase shift layer.

6. The radio of claim 1, wherein the one or more planar antennae form two or more planar antennae, each of the two or more planar antennae underlying the plurality of individually addressable LC pixels.

7. The radio of claim 6, wherein:
the two or more planar antennae comprise a respective planar antenna corresponding to each LC pixel of the plurality of individually addressable LC pixels; and
each corresponding LC pixel of the plurality of individually addressable LC pixels overlies the respective planar antenna to cause the respective planar antenna to be arranged to the at least one of receive or transmit the radio signals through the corresponding LC pixel.

8. The radio of claim 6, wherein the radio frequency transceiver circuit is configured to at least one of transmit to or receive from the two or more planar antennae in-phase to cause the beamforming of the radio signals the at least one of received by or transmitted from the two or more planar antennae that arise from phase shifts introduced by the LC phase shift layer.

9. The radio of claim 6, wherein the radio frequency transceiver circuit is configured to at least one of transmit to or receive from each planar antenna of the two or more planar antennae with a corresponding electrical phase shift to cause the beamforming of the radio signals the at least one of received by or transmitted from the two or more planar antennae that arise from sum of electrical phase shifts introduced by the radio frequency transceiver circuit and phase shifts introduced by the LC phase shift layer.

10. The radio of claim 1 according to, comprising:
a first conductor layer providing a ground layer for the plurality of individually addressable LC pixels;
a second conductor layer separated from the first conductor layer by a first dielectric layer, the second conductor layer patterned to provide radiating conductors of the one or more planar antennae; and
a third conductor layer separated from the second conductor layer by a layer of liquid crystal material, the third conductor layer patterned to provide pixel electrodes defining respective pixels of the LC phase shift layer.

11. The radio of claim 1, wherein the one or more planar antennae form two or more planar antennae, the radio further comprising:
a fourth conductor layer patterned into:
a plurality of LC pixel electrodes, each defining a respective pixel of the LC phase shift layer; and
two or more antenna electrodes, each providing a radiating conductor of a respective one of the two or more planar antennae; and
a fifth conductor layer separated from the fourth conductor layer by a layer of liquid crystal material, the fifth conductor layer providing a ground layer for the plurality of individually addressable LC pixels, and wherein the fifth conductor layer is configured to minimise attenuation of signals at least one of received by or transmitted from the two or more planar antennae.

12. The radio of claim 11, further comprising:
a sixth conductor layer providing a corresponding ground layer for the two or more planar antennae, the sixth conductor layer separated from the fourth conductor layer by a second dielectric layer, wherein the fourth conductor layer lies between the second dielectric layer and the layer of liquid crystal material.

13. The radio of claim 1, wherein the one or more planar antennae form two or more planar antennae, the radio further comprising:
a seventh conductor layer patterned into a plurality of LC pixel electrodes, each defining a respective pixel of the LC phase shift layer, wherein each LC pixel electrode also provides a radiating conductor of the two or more planar antennae; and
an eighth conductor layer separated from the seventh conductor layer by a layer of liquid crystal material, the eighth conductor layer providing a ground layer for the plurality of individually addressable LC pixels, and wherein the eighth conductor layer is configured to minimise attenuation of signals at least one of received by or transmitted from the two or more planar antennae, wherein the radio frequency transceiver circuit is capacitively coupled to each of the two or more planar antennae.

14. The radio of claim 13, further comprising:
a ninth conductor layer providing a corresponding ground layer for the two or more planar antennae, the ninth conductor layer separated from the seventh conductor layer by a third dielectric layer, wherein the seventh conductor layer lies between the third dielectric layer and the layer of liquid crystal material.

15. The radio of claim 1, wherein the one or more planar antennae form two or more planar antennae, the radio comprising:
a tenth conductor layer patterned into two or more antenna electrodes, each providing a radiating conductor of a respective one of the two or more planar antennae;
an eleventh conductor layer separated from the tenth conductor layer by a fourth dielectric layer, the eleventh conductor layer providing a ground layer for the plurality of individually addressable LC pixels, and wherein the eleventh conductor layer is configured to minimise attenuation of signals at least one of received by or transmitted from the two or more planar antennae; and
a twelfth conductor layer separated from the eleventh conductor layer by a layer of liquid crystal material, the twelfth conductor layer patterned into a plurality of LC pixel electrodes, each defining a respective pixel of the LC phase shift layer.

16. The radio of claim 15, further comprising:
a thirteenth conductor layer providing a corresponding ground layer for the two or more planar antennae, the thirteenth conductor layer separated from the tenth conductor layer by a fifth dielectric layer, wherein the tenth conductor layer lies between the fifth dielectric layer and the fourth dielectric layer.

17. The radio of claim 1, further comprising:
a second LC phase shift layer comprising a plurality of individually addressable second LC pixels, wherein a second path length of each corresponding second LC pixel of the plurality of individually addressable second LC pixels varies as a corresponding function of a respective voltage applied across the corresponding second LC pixel;
one or more second planar antennae, each second planar antenna of the one or more second planar antennae arranged to at least one of receive or transmit radio signals through the second LC phase shift layer; and
a second active matrix transistor array, each transistor configured to control a second corresponding voltage across a corresponding second storage capacitor, wherein each second storage capacitor is connected across a respective second LC pixel of the plurality of individually addressable second LC pixels, wherein the radio frequency transceiver circuit is connected to the one or more second planar antennae, wherein the controller is further configured to:
perform second beamforming of second radio signals at least one of received by or transmitted from the one or more second planar antennae by controlling the second active matrix transistor array to set the second path length for each of the plurality of individually addressable second LC pixels;
control, using the active matrix transistor array, the one or more planar antennae as a first phased array to receive the radio signals, the first phased array being directional and controllably orientable to a receive direction; and
control, using the second active matrix transistor array, the one or more second planar antennae as a second phased array to retransmit the radio signals received using the first phased array, the second phased array being directional and controllably orientable to a transmit direction.

18. The radio of claim 17 further comprising a planar substrate having a first face and second face that oppose each other, the planar substrate having a thickness between the first face and the second face, wherein:
the one or more planar antennae and the LC phase shift layer are supported on the first face;
the one or more second planar antennae and the second LC phase shift layer are supported on the second face;
the radio frequency transceiver circuit is supported by the planar substrate; and
the radio frequency transceiver circuit comprises a plurality of vias formed through the thickness of the planar substrate for transmission of signals between the radio frequency transceiver circuit and one or more of the one or more planar antennae or the one or more second planar antennae.

19. A system comprising:
two or more radios, wherein each radio of the two or more radios is configured to coordinate beamforming with each other radio of the two or more radios, wherein each of the two or more radios comprises:
a liquid crystal (LC) phase shift layer comprising a plurality of individually addressable LC pixels, wherein a path length of each corresponding LC pixel of the plurality of individually addressable LC pixels varies as a function of a voltage applied across the corresponding LC pixel;
one or more planar antennae, each planar antenna of the one or more planar antennae being arranged to at least one of receive or transmit radio signals through the LC phase shift layer;
an active matrix transistor array, each transistor of the active matrix transistor array configured to control a corresponding voltage across a corresponding storage capacitor, wherein each storage capacitor is connected across a respective LC pixel of the plurality of individually addressable LC pixels;
a radio frequency transceiver circuit connected to the one or more planar antennae; and
a controller configured to perform beamforming of corresponding radio signals the at least one of received by or transmitted from the one or more planar antennae by controlling the active matrix transistor array to set the path length for each of the plurality of individually addressable LC pixels.

20. The system of claim 19, wherein the two or more radios are configured to coordinate at least one of the beamforming or beamsteering to direct at least one of reception or transmission of the two or more radios towards a first external source.

21. The system of claim 19, wherein the two or more radios are configured to coordinate the beamforming towards at least two spatially separated external sources.

22. The system of claim 19, wherein the two or more radios are supported by a structure.

23. An antenna assembly comprising:
a liquid crystal (LC) phase shift layer comprising a plurality of individually addressable LC pixels, wherein a path length of each corresponding LC pixel of the plurality of individually addressable LC pixels varies as a function of a voltage applied across the corresponding LC pixel; and
one or more planar antennae formed of metal, each planar antenna of the one or more planar antennae arranged to at least one of receive or transmit radio signals through the LC phase shift layer, wherein each planar antenna of the one or more planar antennae is configured for corresponding radio signals having a frequency within a range from about 5 GHz to about 300 GHz.

24. The antenna assembly of claim 23 further comprising
an active matrix transistor array, each transistor of the active matrix transistor array configured to control a corresponding voltage across a corresponding storage capacitor, wherein each storage capacitor is connected across a respective LC pixel of the plurality of individually addressable LC pixels.

25. A method comprising:
controlling, by a controller of a radio, beamforming of radio signals associated with one or more planar antennae of the radio by controlling an active matrix transistor array of the radio to set a path length for each of a plurality of individually addressable liquid crystal (LC) pixels of an LC phase shift layer of the radio, wherein:
the path length of a corresponding LC pixel of the plurality of individually addressable LC pixels varies as a function of a voltage applied across the corresponding LC pixel;
each of the one or more planar antennae is arranged to at least one of receive or transmit the radio signals through the LC phase shift layer;
each transistor is configured to control a corresponding voltage across a corresponding storage capacitor;
each storage capacitor is connected across a respective LC pixel of the plurality of individually addressable LC pixels; and
the radio further comprises a radio frequency transceiver circuit connected to the one or more planar antennae.
